(19) United States
(12) Patent Application Publication
(10) Pub. No.: US 2007/0226620 A1
(43) Pub. Date: Sep. 27, 2007

(54) Information reproducing apparatus and information reproducing method

(75) Inventor: Yuuichi Togashi, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/723,324

(22) Filed: Mar. 19, 2007

(30) Foreign Application Priority Data
Mar. 24, 2006 (JP) 2006-082058

(51) Int. Cl. G06F 3/00

(52) U.S. Cl. 715/700; 711/100

(57) ABSTRACT

Employment of system parameters can be controlled according to a disc type, and then, a proper operation can be obtained. Provided are means for, in the case where output setting information of any of an aspect, resolution, and audio is changed in the middle of playback of first contents, changing setting of a playback section according to the output setting information, and means for, in the case where output setting information of any of an aspect, resolution, and audio is changed in the middle of playback of second contents, establishing a playback state from an object start position of an object of the second contents.

### CROSS-REFERENCE TO RELATED APPLICATIONS

This application is based upon and claims the benefit of priority from Japanese Patent Application No. 2006-082058, filed Mar. 24, 2006, the entire contents of which are incorporated herein by reference.

### BACKGROUND

1. Field

One embodiment of the invention relates to an information reproducing apparatus and an information reproducing method, and particularly to improvement of the apparatus and method for managing setting changes such as an aspect, resolution, and a voice output.

2. Description of the Related Art

Recently, a Digital Versatile Disc (DVD) and a reproducing apparatus therefor have been prevalent, and a High Definition DVD (High Density DVD) enabling high-density recording and high quality recording has also been developed. Such a reproducing apparatus is disclosed in patent document 1.

This reproducing apparatus is compatible with plural types of discs and has a function of determining which disc has been mounted. This can contribute to improvement of operability without a user's inconvenience in disc check.

In addition, a setting management function for managing aspect and resolution changes is generally provided in a disc reproducing apparatus (refer to Jpn. Pat. Appln. KOKAI Publication No. 11-196412).

When a user assigns an operational input such as aspect change or resolution change to the player while a player plays back a video image signal and outputs it to a display device, the player carried out such aspect change and resolution change.

Note that, if the player makes aspect and resolution changes according to the operational input while a specific disc is played back by means of the player, such changes may be inconvenient.

In the player and playing method for advanced contents according to the present invention, contents, programs, applications and the like can be acquired from the outside. Then, the external data and the data recorded in a disc are combined with each other, whereby the combined data is played back and outputted or a playback route is changed according to a user operation. Thus, aspect or resolution change is made in the middle of playback, there occurs a case incompatible with a current playback operation.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are explanatory diagrams showing a configuration of standard contents and advanced contents;

FIGS. 2A to 2C are explanatory diagrams of discs in categories 1, 2, and 3;

FIG. 3 is an explanatory diagram showing a reference example of an enhanced video object (EVOB) using time map information (TMAPI);

FIG. 4 is an explanatory diagram to help explain an example of a volume space of the disc according to this invention;

FIG. 5 is an explanatory diagram showing an example of a directory and a file of the disc according to this invention;

FIG. 6 is an explanatory diagram showing a configuration of management information (VMG) and a video title set (VTS) according to this invention;

FIG. 7 is an explanatory diagram showing a startup sequence of a player model according to this invention;

FIG. 8 is a diagram showing a data structure of a DISCID.DAT file of the disc according to this invention;

FIG. 9 is a flowchart showing an exemplary operation of the apparatus according to this invention;

FIG. 10 is a flowchart showing another exemplary operation of the apparatus according to this invention;

FIG. 11 is a flowchart showing further another exemplary operation of the apparatus according to this invention;

FIG. 12 is a schematic explanatory diagram showing a pack-mixed state of primary EVOB-TY2 according to this invention;

FIG. 13 is an explanatory diagram showing a concept of recorded information of the disc according to this invention;

FIG. 14 is an explanatory diagram showing in detail a model of an advanced content player according to this invention;

FIG. 15 is an explanatory diagram showing an example of a video mixing model of FIG. 14;

FIG. 16 is an explanatory diagram to help explain an example of a graphics hierarchy in an operation of the apparatus according to this invention;

FIG. 17 is an explanatory diagram showing an example of a supply model of a network and persistence storage data in the apparatus according to this invention;

FIG. 18 is an explanatory diagram showing an example of a data store model in the apparatus according to this invention;

FIG. 19 is an explanatory diagram showing an example of a user input handling model in the apparatus according to this invention;

FIGS. 20A and 20B are diagrams to help explain an exemplary configuration of an advanced content;

FIG. 21 is a diagram to help explain an exemplary configuration of a play list;

FIG. 22 is a diagram to help explain an example of allocation of presentation object on a timeline;

FIG. 23 is a diagram to help explain a case where trick play (such as chapter jump) of presentation objects is performed on the timeline;

FIG. 24 is a diagram to help explain an exemplary configuration of a play list in the case where an object includes angle information;

FIG. 25 is a diagram to help explain an exemplary configuration of a play list in the case where an object includes a multi-story;

FIG. 26 is a diagram to help explain an exemplary description of object mapping information in the play list and its playback time;

FIG. 27 is a flowchart showing how a data cache is controlled at the time of apparatus operation using the play list;

FIG. 28 is a view showing an example of a comment displayed in response to an operation of a user interface manager; and

FIG. 29 is a diagram showing a whole block configuration of a player according to this invention.

### DETAILED DESCRIPTION

Various embodiments according to the invention will be described hereinafter with reference to the accompanying drawings.

It is an object of this embodiment to provide an information reproducing apparatus and an information reproducing method capable of controlling employment of system parameters according to disk types so as to obtain a proper operation.

In this embodiment, the information recording apparatus has: a playback processing section which, in order to play back disk contents, plays back the contents based on playback management information; a continuation control section which, in the case where output setting information of any of aspect, resolution and audio has been changed in the middle of reproduction of first contents from the disc, changes setting of the playback processing section according to the output setting information, and continues playback; and a replay control section which, in the case where output setting information of any of aspect, resolution, and audio has been changed in the middle of playback of second contents from the disc, establishes the playback processing section in a playback state from an object start position of an object of the disc.

By the means described above, proper management of the output setting information is enabled, and playback is carried out smoothly according to discs of plural types.

Hereinafter, embodiments of this invention will be described with reference to the accompanying drawings.

<Introduction>

A description will be given with respect to types of contents.

In the following description, two types of contents are defined. One is Standard Content, and the other is Advanced Content. The Standard Content is composed of navigation data and video objects on a disc, and obtained by extending version 1.1 of the DVD-video standard.

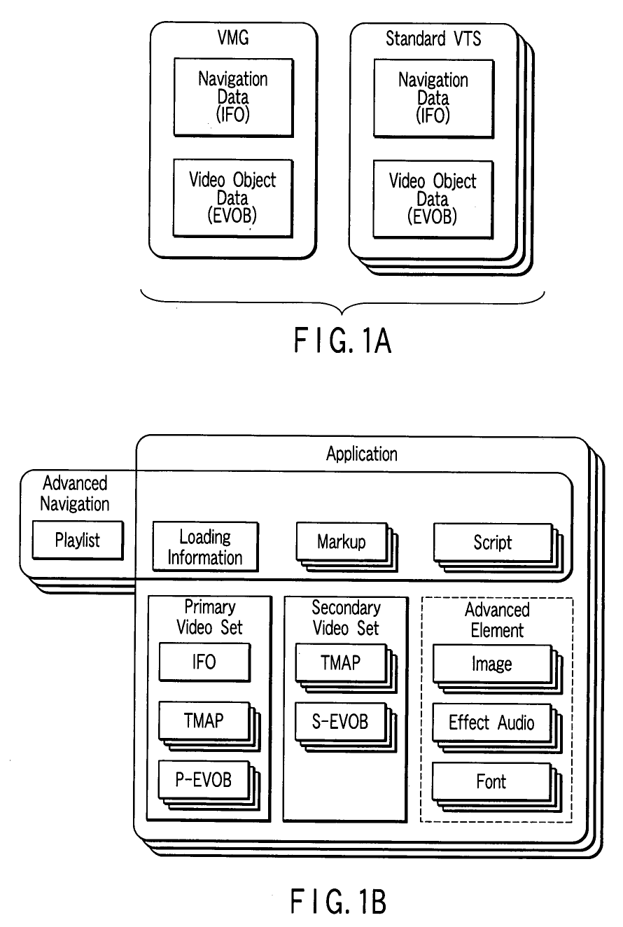

On the other hand, the Advanced Content is composed of: Advanced Navigation data such as a Playlist, Loading Information, a Markup, Script Files; Advanced data such as a Primary/Secondary Video Set; and Advanced Elements (such as images, audios, and texts). This advanced content needs to locate at least one playlist file and primary video set on a disc, and other data may be located on the disc or may be acquired from a server.

<Standard Content (Refer to FIG. 1A)>

The Standard Content is an extension of the contents defined in version 1.1 of the DVD-video standard with respect to some of new functions of high-resolution videos and high quality audios, in particular. The Standard Content is basically composed of one VMG space and one or plural VTS spaces (referred to as “standard VTS” or mere “VTS”).

<Advanced Content (Refer to FIG. 1B)>

The Advanced Content realizes more high-level interactivity in addition to audio and video extension realized by the Standard Content. The Advanced Content is composed of: Advanced Navigation such as a Playlist, Loading Information, a Markup, and Script files, Advanced data such as Primary/Secondary Video Sets, and Advanced Elements (such as images, audios, and texts), and the Advanced Navigation manages playback of the advanced data.

The playlist described in XML exists on a disc. In the case where the Advanced Content exists on the disc, a player first executes this file. The following pieces of information are provided using this file.
Object Mapping Information: information in the title for presentation object mapped on Title Timeline.
Playback Sequence: playback information for each title described by title timeline.
Configuration Information: System configuration information such as data buffer alignment.

In the case where the Primary/Secondary Video Sets or the like exist, with reference thereto, a first application is executed in accordance with a description of a Play List. One application is composed of Loading Information, Markup (including content/styling/timing information), Script, and Advanced data. The first markup file, script file, or other resources, configuring an application, are referred to in one loading information file. Playback of advanced data such as the Primary/Secondary Video Sets and Advanced Elements are started by means of markup.

A structure of the Primary Video Set is composed of one VTS space exclusively used for this content. That is, this VTS does not include a navigation command or a multi-layered structure, but includes TMAP information or the like. In addition, this VTS can hold one main video stream, one sub-video stream, 8 main audio streams, and 8 sub-audio streams. This VTS is called “Advanced VTS”.

The Secondary Video Set is used when video/audio data is added to the Primary Video Set and is used when only audio data is added thereto. However, the data can be played back only in the case where playback of video/audio streams in a Primary Video Set is not carried out. In other words, if such playback is carried out, the data cannot be played back.

The Secondary Video Set is recorded on a disc or is acquired from a server as one or plural files. In this file, data is recorded on the disc. Moreover, in the case where there is a need for reproducing the recorded data at the same time with the Primary Video Set, they are temporarily stored in a file cache before playback. On the other hand, in the case where the Secondary Video Set exists on a web site, there is a need for temporarily saving the whole data in a file cache (“Downloading”) or continuously saving part of the data in a streaming buffer, and the stored data is reproduced at the same time without causing a buffer overflow while data is downloaded from a server (“Streaming”).

Description of Advanced Video Title Set (Advanced VTS)

The Advanced VTS (also called Primary Video Set) is utilized in a video title set for advanced navigation. That is, the following is defined to be compatible with the standard VTS.

1) Advanced Enhancement of EVOB
One main video stream and one sub-video stream
8 main audio streams and 8 sub-audio streams
32 sub-picture streams
One advanced stream

2) Integration of Enhanced EVOB Set (EVOBS)
Integration of both of menu EVOB and title EVOS

3) Elimination of Multi-layered Structure
No title, PGC (Program Chain), PTT (Part of Title), or Cell
Cancellation of navigation command and UOP (User Operation) control

4) Introduction of New Time Map Information (TMAPI)
One TMAPI corresponds to one EVOB, and is stored as one file.
Part of the NV_PCK internal information is simplified.

Description of Interoperable VTS

An interoperable VTS is a video title set supported under an HD DVD-VR standard. Under the instant standard, i.e., under the HD DVD-video standard, this interoperable VTS is not supported, i.e., a content author cannot produce a disc containing the interoperable VTS. However, an HD DVD-video player supports playback of the interoperable VTS.

<Disc Categories>

Under this standard, three types of discs (disc of category 1/disc of category 2/disc of category 3) defined below are accepted.

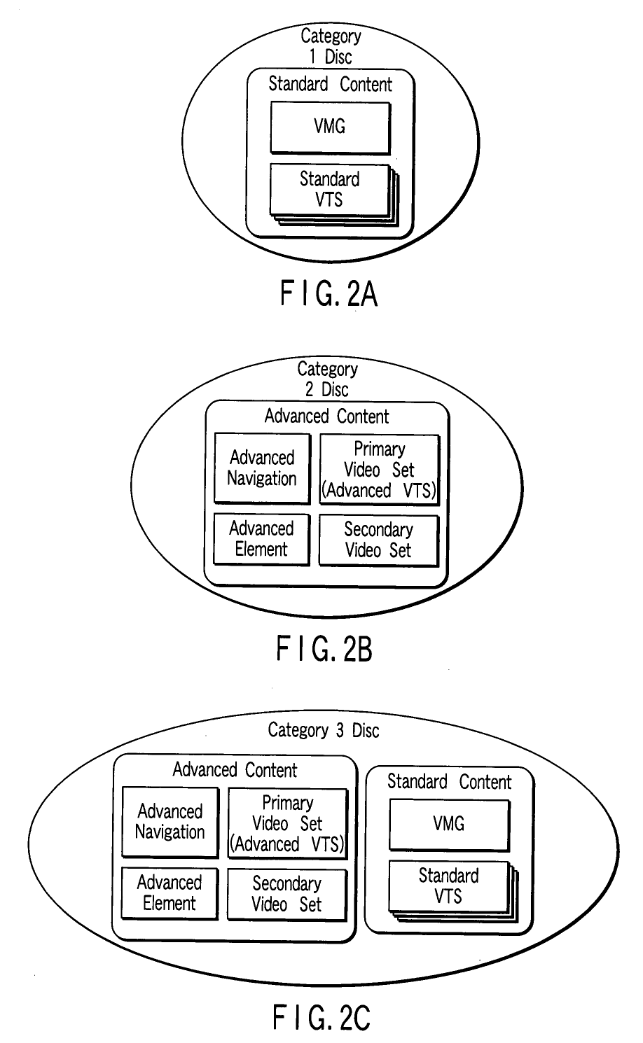

Description of Disc of Category 1 (Refer to FIG. 2A for an Exemplary Configuration Thereof)

This disc contains only a Standard Content composed of one VMG and one or plural standard VTS. That is, this disc does not contain Advanced VTS or Advanced Content.

Description of Disc of Category 2 (Refer to FIG. 2B for an Exemplary Configuration Thereof)

This disc contains only an Advanced Content composed of an Advanced Navigation, a Primary Video Set (Advanced VTS), a Secondary Video Set, and Advanced Elements. That is, this disc does not contain Standard Content such as VMG or Standard VTS.

Description of Disc of Category 3 (Refer to FIG. 2C for an Exemplary Configuration Thereof)

This disc contains Advanced Content composed of an Advanced Navigation, a Primary Video Set (Advanced VTS), a Secondary Video Set, and Advanced Elements and a Standard Content composed of VMG (Video Manager) and one or plural standard VTS. However, in this VMG, neither FP_DOM nor VMGM_DOM exists.

This disc contains Standard Content. Basically, this disc follows rules of the disc of category 2. Furthermore, this disc contains a transition from an advanced content playback state to a standard content playback state, and contains its reversed transition.

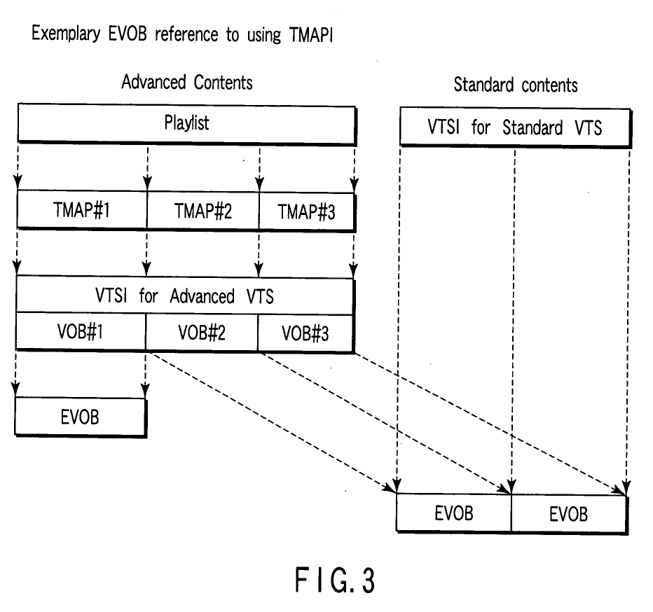

Description of Utilization of Standard Content by Advanced Content (FIG. 3 Shows how Standard Content is Utilized as Described Above)

The Standard Content can be utilized by an Advanced Content. VTSI (Video Title Set Information) of Advanced VTS can refer to EVOB, and the latter can also refer to it using TMAP in accordance with VTSI of Standard VTS. However, EVOB can include HLI (Highlight Information), PCI (Program Control Information) and the like, and is not supported by the Advanced Content. In playback of such EVOB, for example, HLI and PCI are ignored in the Advanced Content.

<Structure of Volume Space>

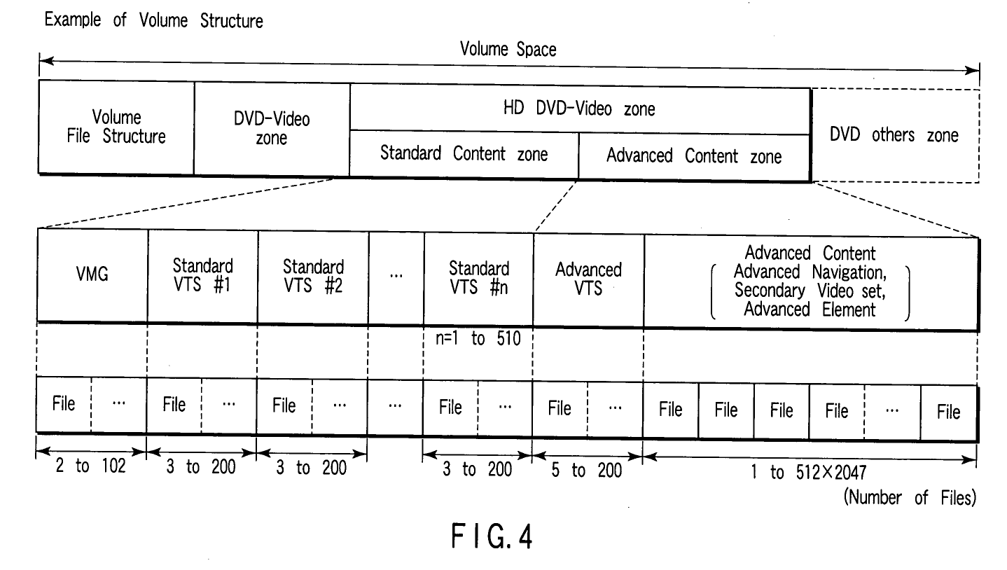

As shown in FIG. 4, a volume space of an HD DVD-video disc is composed of elements as described below.

1) Volume and File Structure

This is allocated for a UDF structure.

2) Single DVD-Video Zone

This may be allocated for a data structure of a DVD-video format.

3) Single HD DVD-Video Zone

This may be allocated for a data structure of a DVD-video format. This zone is composed of a “standard content zone” and an “advanced content zone”.

4) DVD Others Zone

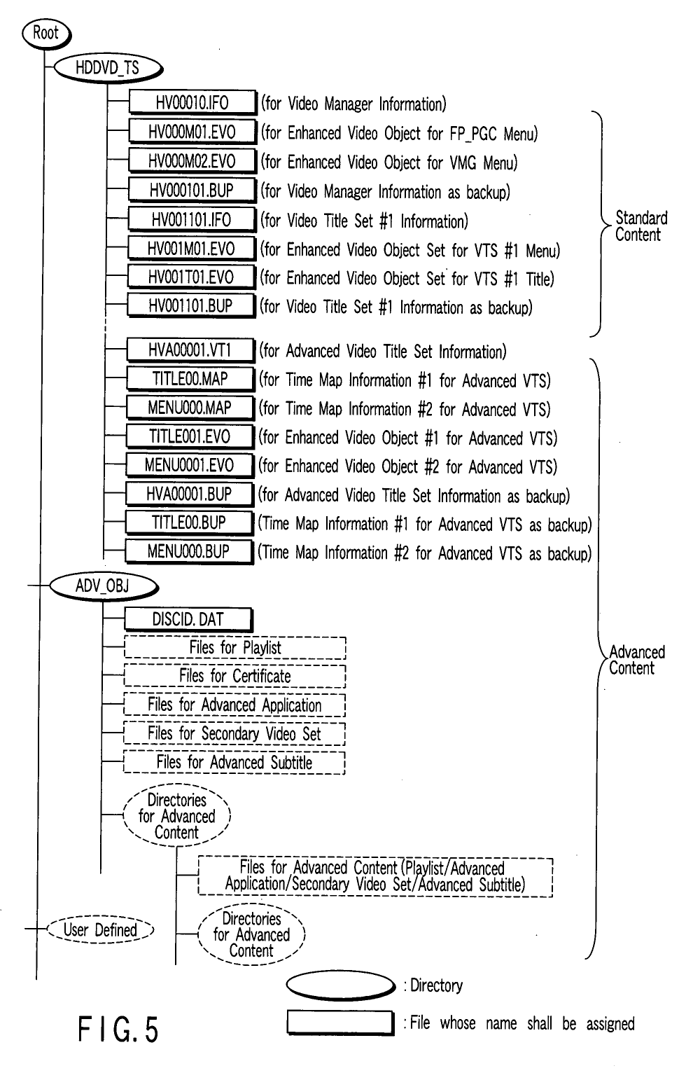

This may be used for applications other than a DVD-video or an HD DVD-video.

<Rules Relating to Directories and Files (FIG. 5)>

A description will be given with respect to requirements for files and directories associated with the HD DVD-video disc. In FIG. 5 showing directories, descriptions of the left side portions enclosed in boxes are file names.

HVDVD_TS Directory

An “HVDVD_TS” directory exists immediately under a root directory. All files associated with one VMG, one or plural standard video sets, and one advanced VTS (primary video set) exist under this directory.

Video Manager (VMG)

One piece of video manager information (VMGI) “HV00010.IFO”, a first play program chain menu enhanced video object (FP_PGCM_EVOB) “HV000M01.EV0”, backup video manager information (VMGI_BUP) “HV000101.BUP”, a video manager menu enhanced video object set (VMGM_EVOBS) “HV000M02.EVO” are recorded under the HVDVD_TS directory as configuration files.

Standard Video Title Set

Video title set information (VTSI) “HV001101.IFO” and backup video title set information (VTSI_BUP) “HV001101.BUP” are recorded under the HVDVD_TS directory as configuration files. In addition, a video title set menu enhanced video object set (VTSM_EVOBS) “HV001M01.EVO” and a title enhanced video object set (VTSTT_VOBS) “HV001T01.EVO” are also configuration files under the HVDVD_TS directory.

Advanced Video Title Set (Advanced VTS)

One piece of video title set information (VTSI) “HVA00001.VT1” and one piece of backup video title set information (VTSI_BUP) “HVA00001.BUP” can be recorded under the HVDVD_TS directory as configuration files.

Pieces of video title set time map information (VTS_TMAP) #1 (for titles) and #2 (for menus), “TITLE00.MAP” and “MEMU000.MAP”; and pieces of backup video title set time map information (VTS_TMAP_BUP) #1 and #2, i.e., “TITLE00.BUP” and “MENU000.BUP” are composed of files under the HVDVD_TS directory, respectively.

Files “TITLE00.EVO” and “MENU000.EVO” of enhanced video objects #1 and #2 for an enhanced video title set are also configuration files under the HVDVD_TS directory.

The following rules are applied to file names and directory names under the HVDVD_TS directory.

ADV_OBJ Directory

An “ADV_OBJ” directory is immediately under the root directory. All of startup files belonging to Advanced Navigation exist in this directory. All of the files of Advanced Navigation, Advanced Elements, and Secondary Video Set exist in this directory.

In addition, immediately under this directory, a file “DISCID.DAT” unique to an advanced system is provided. This file is a disc ID data file, and a detailed description thereof will be given later.

All of the playlist files exist immediately under this directory. Any of the files of Advanced Navigation, Advanced Elements, and Secondary Video Set can be placed immediately under this directory.

Playlist

Each playlist file can be placed by a file name such as “PLAYLIST%%.XPL”, for example, immediately under the “ADV_OBJ” directory. The file names “%%” are continuously allocated in ascending order from “00” to “99”. A playlist file having the greatest number is first processed (when loading a disc).

Advanced Content Directory

An “Advanced Content other directory” can be placed only under the “ADV_OBJ” directory. Any of files of an Advanced Navigation, Advanced Elements, and a Secondary Video Set can be placed under this directory.

Advanced Content File

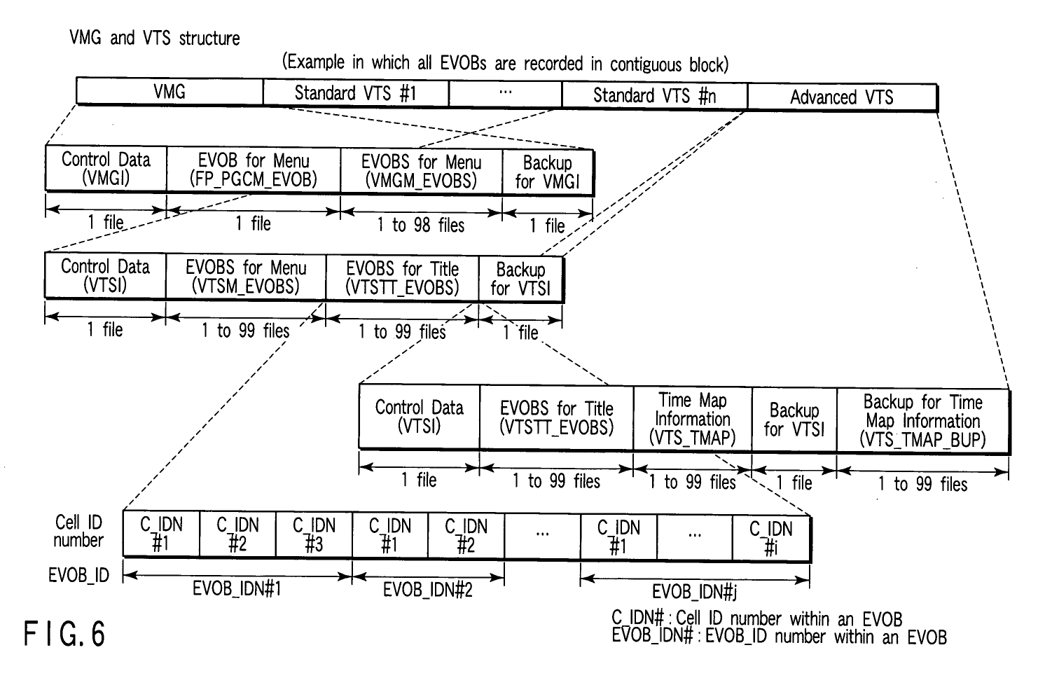

A total number of files under the “ADV_OBJ” directory is limited to 512×2047, and a total number of files existing in each directory is less than 2048. This file name is composed of “d” characters or “d1” characters. This file name is composed of a main body, a period, and an extension. An example of the directory/file structure described above is shown in FIG. 6.

<Structure of Video Manager (VMG) (FIG. 6)>

VMG is a table of contents of all video title sets existing in an “HD DVD-video zone”. As shown in FIG. 6, VMG is composed of: control data called VMGI (Video Manager Information); a first play PGC menu enhanced video object (FP_PGCM_EVOB); a BMG menu enhanced video object set (VMGM_EVOBS); and control data backup (VMGI_BUP). The control data is static information required to reproduce a title, and provides information for supporting a user operation. FP_PGCM_EVOB is an enhanced video object (EVOB) used to select a menu language. VMGM_EVOBS is a set of enhanced video objects (EVOB) used for a menu that supports a volume access.

<Structure of Standard Video Title Set (Standard VTS)>

VTS is a set of titles. As shown in FIG. 6, each VTS is composed of: control data called VTSI (Video Title Set Information); a VTS Menu Enhanced Video Object Set (VTSM_EVOBS); a Title Enhanced Video Object Set (VTSTT_EVOBS); and Backup Control Data (VTSI_BUP).

<Structure of Advanced Video Title Set (Advanced VTS)>

This VTS is composed of only one title. As shown in FIG. 6, the VTS is basically composed of: control data called VTSI; a Title Enhanced Video Object Set (VTSTT_EVOBS) in one VTS; Video Title Set Time Map Information (VTS_TMAP); Backup Control Data (VTSI_BUP); and Backup of the Video Title Set Time Map Information (VTS_TMAP_BUP).

<Structure of Enhanced Video Object Set (EVOBS)>

EVOBS is a set of enhanced video objects composed of videos, audios, and sub-pictures (FIG. 6).

The following rules are applied to EVOBS.

1) In one EVOBS, EVOB is recorded in continuous blocks and interleaved blocks.

2) One EVOBS is composed of one or plural EVOB. EVOB_ID numbers are assigned in ascending order starting from EVOB having the smallest LSN (logic sector number) in EVOBS.

3) One EVOB is composed of one or plural cells. C_ID numbers are assigned in ascending order starting from a cell having the smallest LSN in EVOB.

4) The cells in EVOBS can be identified using EVOB_ID numbers and C_ID numbers.

“System Model”

<Overall Startup Sequence>

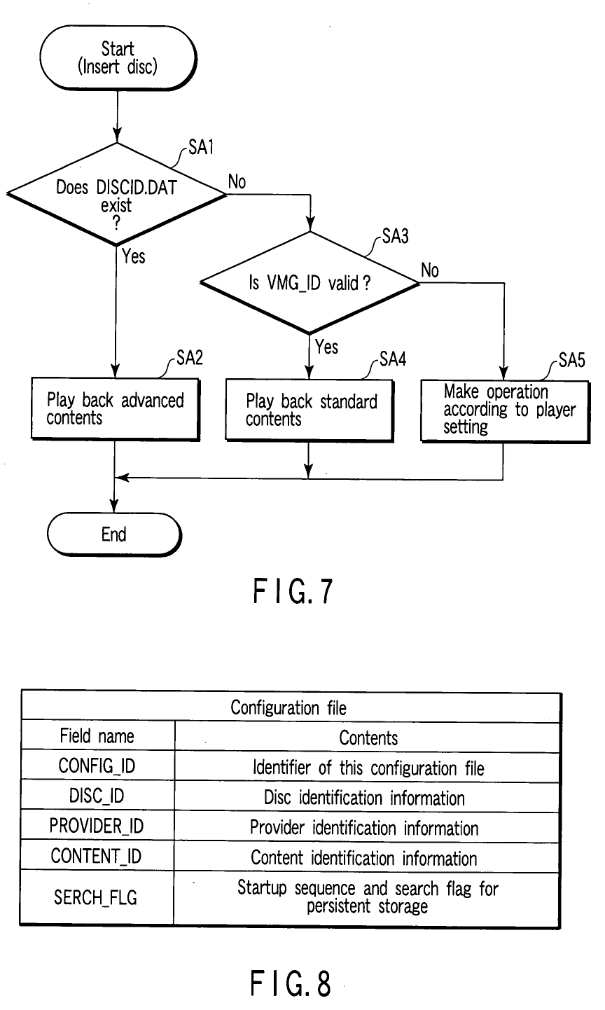

FIG. 7 shows a flowchart of a startup sequence of an HD DVD player. After a disc has been inserted, the player first checks the existence of a file “DISC.DAT” under the “ADV_OBJ” directory in a management information region (step SA1). “DISC.DAT” is a file specific to a recording medium which can handle advanced content. When “DISC.DAT” is confirmed, the routine moves to an advanced content playback mode (step SA2). At this time, a disc of category 2 or 3 is used. In the case where “DISC.DAT” has not confirmed in step SA1, it is checked whether or not “VMG_ID” is valid (step SA3). Whether or not “VMG_ID” is valid is checked as follows. If a disc belongs to category 1, “VMG_ID” is “HVDVD-VMG100”. In addition, bits 0 to 3 of VMG_CAT that is a category description region indicates that “No Advanced VTS exists”. In this case, the player moves to a standard content playback mode (step SA4). Further, in the case where it is determined that the disc does not belong to any HD_DVD type, an operation that follows the player's setting is ready (step SA5).

When the routine moves to advanced content playback, the player moves to an operation of reading and reproducing “playlist.xml (Tentative)” of the “ADV_OBJ” directory under the root directory. A startup sequence, a memory for that purpose and the like may be provided in a data access manager or a navigation manager.

Here, FIG. 8 shows a data structure of the previously described “DISCID.DAT”. “DISCID.DAT” is a file name, and is also called a configuration file. In this file, a plurality of fields are allocated, and these fields include “CONFIG_ID”, “DISC_ID”, “PROVIDER_ID”, “CONTENT_ID”, “SEARCH_FLAG” and the like.

In the “CONFIG_ID” field, “HDDVD-V_CONF” for identifying this file is described in ISO8859-1 codes.

A disc ID is described in the “DISC_ID” field.

A studio ID is described in “PROVIDER_ID”. Using this information, a content provider can be identified. Persistent Storage has an independent area for storing data by provider ID for each provider. Advanced content identification information is described in the “CONTENT_ID” field. This content ID can also be utilized to make a search for a playlist file contained in Persistent Storage.

A “SERCH_FLAG” field is a search flag for making a search for files of Persistent Storage at the time of a start sequence. When this flag is set to 1, it denotes that the Persistent Storage is not available. When the flag is set to 0, it denotes that the Persistent Storage is available. Therefore, when the above flag is set to 0, a player makes a search for playlist files in both of the disc and Persistent Storage. When the flag is set to 1 and startup occurs, a search is made for the playlist file only from the disc.

Therefore, the above configuration file data is utilized to identify a region allocated to a disc, in Persistent Storage. In addition, this data is also utilized in the case where disc authentication is carried out through a network. For example, provider information exists, and thus, utilizing this provider information, a search can be made for a server who owns information relating to this disc.

The player according to the present invention executes processing relating to a data structure of the above “DISCID.DAT” in the case where a resume function operates.

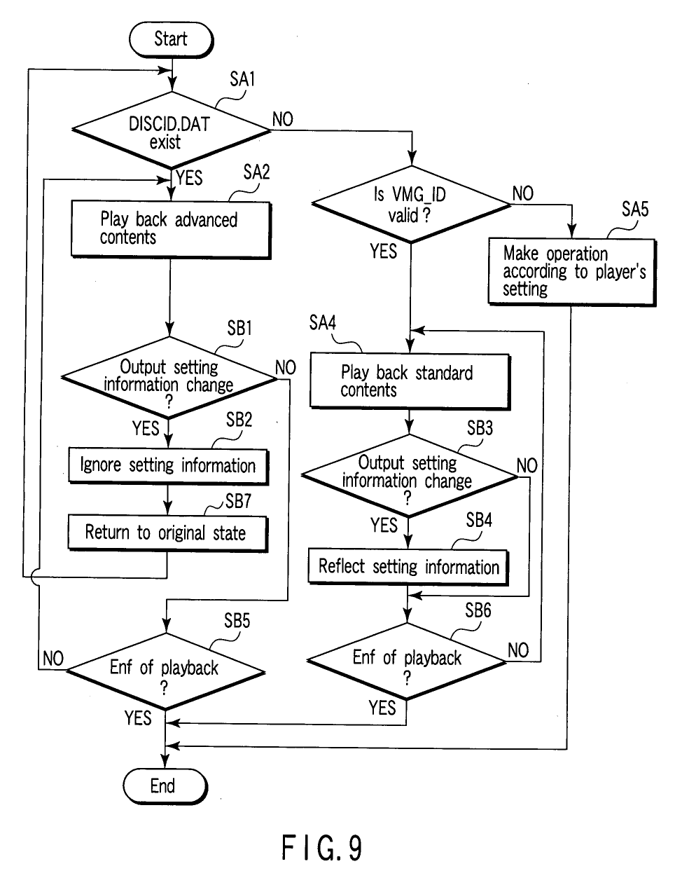

FIG. 9 is a flowchart showing an exemplary operation when output setting information (system parameters) has been changed. If the output setting information is changed while a playback state of advanced contents is established (step SA2), the setting information is ignored (step SB2). In this case, for example, the routine reverts to its original state (step SA1) in which the setting information is reset to the playback processing section, and then, playback is started. When playback is terminated (step SB5), the player's operation is terminated.

In contrast, if output setting information is changed while a playback state of standard contents is established (step SA4), the setting information is reflected in the player (step SB4). When playback is terminated (step SB6), the player's operation is terminated.

Here, the output setting information includes aspect setting information, resolution setting information, audio output setting information, and HDMI (high definition multimedia interface) setting information. The aspect includes setting information such as 4:3 or 16:9. In addition, the resolution includes setting information such as 480 pixels, 720 pixels, and 1080 pixels per line.

The audio output setting information includes parameters of audio systems (such as PCM, Dorby, and MPEG systems) in which the number of output channels, main audio, and sub audio are supported. The HDMI includes up conversion and down conversion of image data.

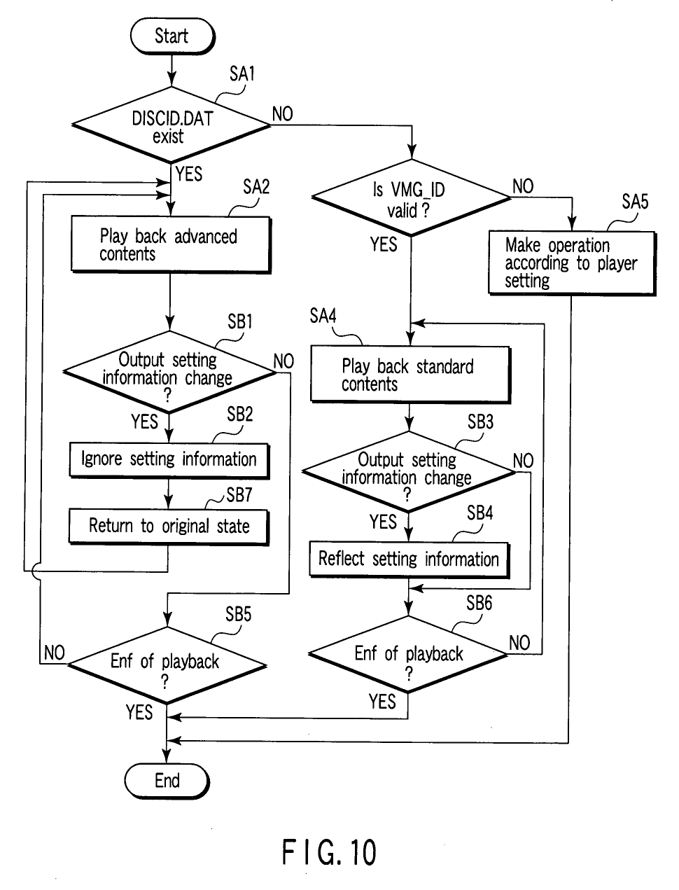

FIG. 10 shows another embodiment of procedures shown in FIG. 9. In FIG. 9, when a playback object is advanced contents and output setting information has been changed, the routine has reverted to step SA1. In the case where the object is advanced contents, however, DISCID.DAT is left in a memory, and the routine may revert to step SA2 (step SB7).

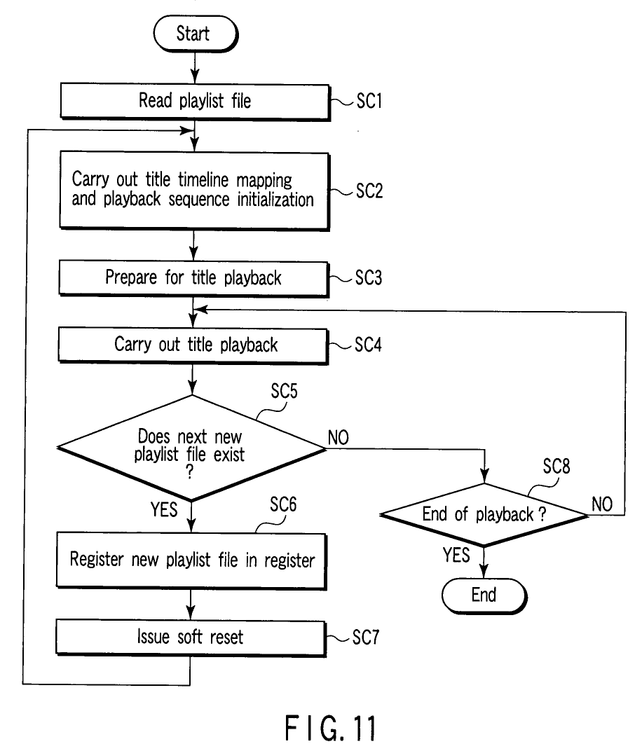

In this case, as shown in FIG. 11, the routine reverts to advanced content playback.

“Play list file reading” is carried out (step SC1). Title timeline mapping and playback sequence initialization are carried out using a next playlist (step SC2). Next, first title playback is ready (step SC3), and then, title playback is started (step SC4). In this manner, an advanced content player reproduces a title. Next, it is determined whether or not a new playlist file exists (step SC5). An advanced application that executes updating procedures is required to update advanced content playback. In the case where the advanced application updates that presentation, the advanced application on the disc must make a search for, and update a script sequence in advance. A programming script makes a search for a designated data source, generally a network server, whether or not an available new playlist file exists. In the case where a new playlist file exits, the registration of the playlist file is executed (step SC6). In the case where an available new playlist file exists, a script executed by a programming engine downloads it in a file cache, and registers it in an advanced content player. Then, when the new playlist file is registered, an Advanced Navigation issues soft reset API (step SC7), and then, restarts a startup sequence. The soft reset API resets all of the current parameters and playback configurations, and then, restarts startup procedures immediately after “playlist file reading”. “System configuration change” and the subsequent procedures are executed based on the newly read playlist file.

As described above, a reason why the routine reverts to the first playback state of contents is that the following considerations are taken. With respect to advanced contents, the following designs by a provider are allowed. That is, (1) applications and contents per se may be prepared, respectively, according to resolution. (2) Applications and contents per se may be prepared, respectively, according to an aspect. (3) Applications and contents per se may be prepared, respectively, according to a voice output environment. (4) Applications and contents per se may be prepared, respectively, according to use of the HDMI.

Therefore, if resolution or the like is changed in the middle of playback, it is not compensated that an application compatible to that resolution is properly enabled. In order to make such compensation, in this apparatus, in the case where an output environment is changed in the middle of playback, the routine reverts to the first playback state.

In addition, in playback of advanced contents, an interactive behavior can be achieved in response to a user operation. Thus, a next playback route or a playback position on contents is changed or switched in response to the user operation.

Therefore, in the case where output setting information is changed during playback, operations as shown in FIGS. 9 and 10 are required.

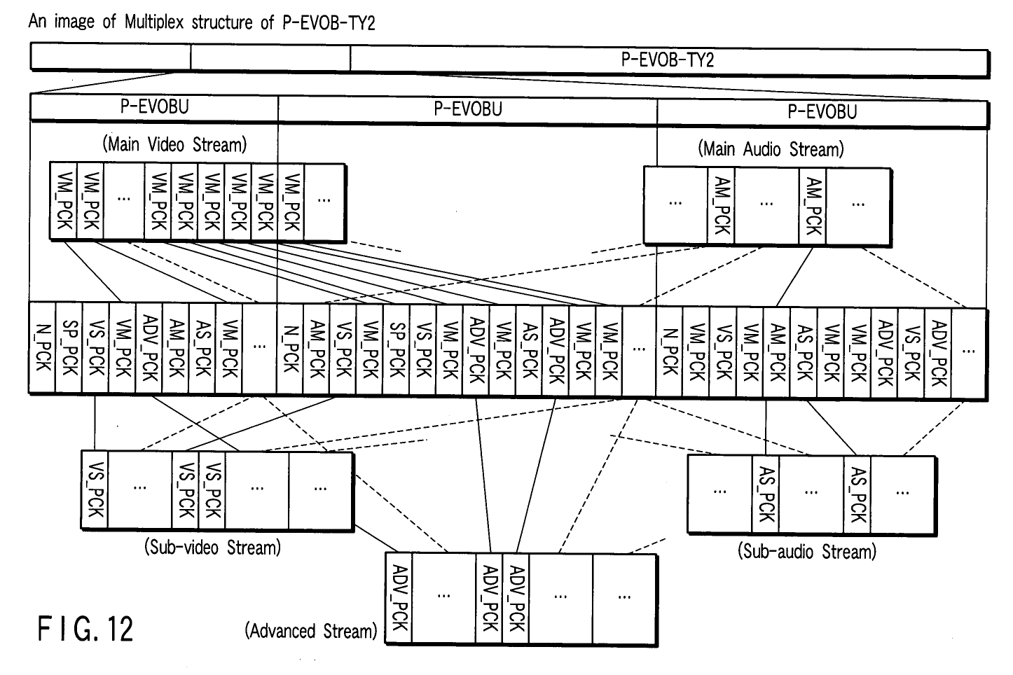

FIG. 12 is an image of a multiplexed structure of P-EVIOB-TY2 as an advanced content. P-EVOB-TY2 includes an enhanced video object unit (P-EVOBU). P-EVOBU includes a Main Video stream, a Main Audio stream, a Sub Video stream, a Sub Audio stream, and an Advanced stream.

At the time of playback, a packet-multiplexed stream of P-EVOB-TY2 is inputted to a De-Multiplex via a Track buffer. Here, packets are demultiplexed according to their types, and then, the demultiplexed packets are supplied to a Main Video Buffer, a Sub Video Buffer, a Sub-Picture Buffer, a PCI Buffer, a Main Audio buffer, and a Sub Audio buffer. The outputs from these buffers can be decoded using the corresponding Decoder.

<Data Source>

Now, a description will be given with respect to types of data sources that can be used for advanced content playback.

<Disc>

A disc 131 is a mandatory data source for advanced content playback. An HD DVD player must be equipped with an HD DVD disc drive. Advanced Content needs to carry out authoring so as to enable playback even in the case where an available data source is only a disc and a mandatory persistent storage.

<Network Server>

A network server 132 is an optional data source for advanced content playback, and the HD DVD player must be equipped with network access capability. A current disc content provider generally operates the network server. The network server is, in general, located over the Internet.

<Persistent Storage>

A Persistent Storage 133 is divided into two categories.

One is called a “Fixed Persistent Storage”. This is a mandatory persistent storage provided as accessories to the HD DVD player. A typical example of this storage includes a flash memory. The minimum capacity of the Fixed Persistent Storage is 64 MB.

Other devices are optional, and are called “Auxiliary Persistent Storage”. These devices may be removable storage devices such as a USB memory/HDD or a memory card. One of the possible auxiliary persistent storage devices includes NAS. This standard does not stipulate device packaging. These devices must follow an API model for persistent storage.

<Disc Data Structure>

<Data Type on Disc>

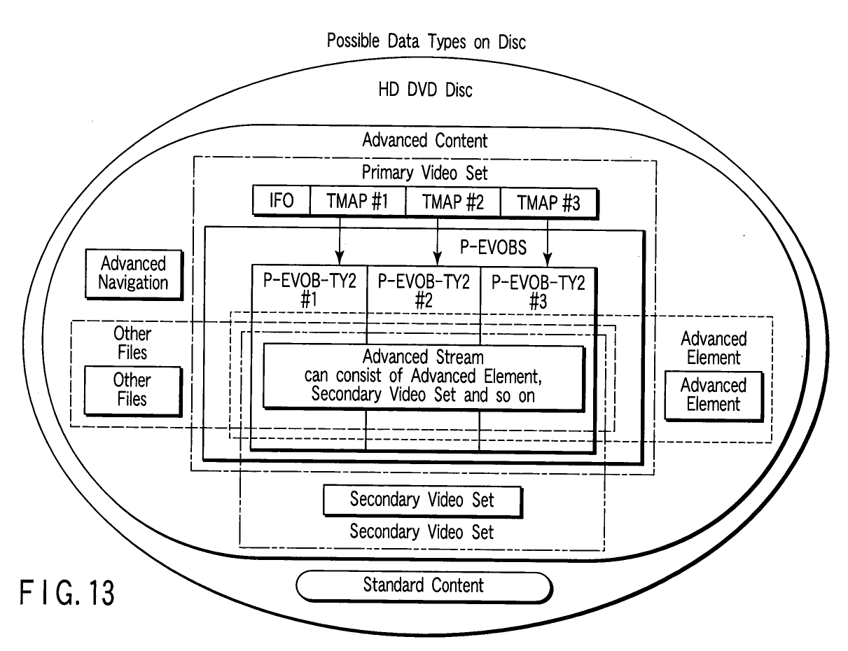

FIG. 13 shows data types that can be stored on an HD DVD disc. The disc can store both of the advanced content and the standard content. Available data types of the advanced content include: an Advanced Navigation, Advanced Elements, a Primary Video Set, a Secondary Video Set and the like.

FIG. 13 shows exemplary data types on a disc. An Advanced Stream is a data format for archiving any type of advanced content file excluding a Primary Video Set. The Advanced Stream is multiplexed to a Primary Enhanced Video Object Type 2 (P-EVOBS-TY2), and then, is drawn together with P-EVOBS-TY2 data supplied to a primary video player.

The same file that is archived in the Advanced Stream and that is mandatory for advanced content playback needs to be stored as a file. These copies guarantee advanced content playback. This is because advanced stream supply may not be completed when playback of the Primary Video Set jumps. In this case, necessary files are directly read from a disc to Data Cache before restarting playback from a designated jump position.

Advanced Navigation: An Advanced Navigation file is located as a file. The Advanced Navigation file is read between startup sequences, and then, the read file is interpreted for advanced content playback.

Advanced Elements: Advanced Elements can be located as a file and can be archived in an Advanced Stream multiplexed to P-EVOB-TY2.

Primary Video Set: Only one Primary Video Set exists on a disc.

Secondary Video Set: A Secondary Video Set can be located as a file and can be archived in an Advanced Stream multiplexed to P-EVOB-TY2.

Other Files: Other files may exist depending on an Advanced Content.

<Data Type on Network Server and Persistent Storage>

All of the Advanced Content files excluding a Primary Video Set can be placed on a network server and a persistent storage. An Advanced Navigation can copy a file stored on the network server or Persistent Storage to a File Cache, using correct API. A Secondary Video Player can read a Secondary Video Set from a network server or persistent storage into a streaming buffer. The Advanced Content file excluding the Primary Video Set can be stored in the Persistent Storage.

<Details of Advanced Content Player Model>

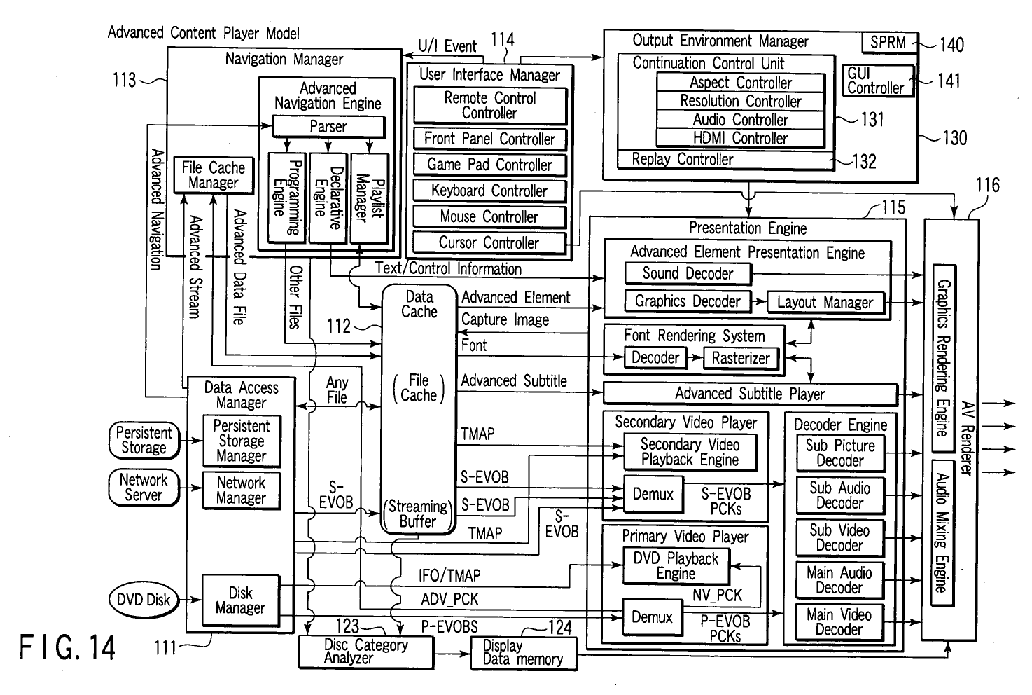

FIG. 14 shows an Advanced Content Player Model in detail.

An Advanced Content Player is a logical player for advanced contents. Advanced content data sources include: a Disc 131, a Network Server 132, and a Persistent Storage 133. The Advanced Content Player is compatible with these data sources.

Any data type of advanced contents can be stored on the disc. With respect to the Advanced Contents for the Persistent Storage and the Network Server, any data type excluding the Primary Video Set can also be stored.

A user event entry is made by a user input device such as a remote controller or a front panel of an HD DVD player. The Advanced Content Player is responsible for entry of user events into the Advanced Contents and generation of a correct response. Audio and video outputs are sent to a speaker and a display device, respectively.

The Advanced Content Player is a logical player for advanced contents. This player primarily comprises six logical function modules, i.e., a Data Access Manager 111; a Data Cache 112; a Navigation Manager 113; a User Interface Manager 114; a Presentation Engine 115; and an AV Renderer 116. These elements form a playback processing section.

Further, the player has a Disc Category Analyzer 123 and a Display Data Memory 124. The Disc Category Analyzer 123 judges category of a currently mounted disc based on information and commands acquired in the Data Cache 112 and the Navigation Manager 113. In addition, when the routine reverts from an Advanced Content playback state to a Standard Content playback state or vice versa while the disc of category 3 is mounted, its state can be sensed.

Further, an output environment manager 130 is provided. This output environment manager 130 changes output setting information (system parameters) mainly in response to the user operation, and then, sets an output configuration. For example, aspect, resolution, audio output channels and the like are set. A position at which the output environment manager 130 is provided is not limited to the position illustrated, and may be incorporated in another block.

In order to play back a disc, a playback processing section for playing back the disc based on playback management information is mainly composed of: a disc access manager 111, a data cache 112, a navigation manager 113, a user interface manager 114, a presentation engine 115 and the like. The output setting information described above is assigned to a decoder engine block in the presentation engine 115.

The output environment manager 130 described above has a Continuation Controller 131 and a Replay Controller 123. In the case where the output setting information of any of aspect, resolution and audio is changed in the middle of playback of standard contents, the Continuation Controller 131 changes setting of the playback processing section and continues playback in response to the output setting information. The Continuation Controller 131 includes an Aspect Controller, a Resolution Controller, an Audio Controller, and an HDMI Controller. Each controller operates in response to a command inputted via a graphic user interface manager 114 (which may be a graphic user interface control section) by the user operation. In addition, such each controller operates when equipment has been powered ON. When the equipment has been powered ON, the output setting state established when the equipment has been powered OFF previously is set for this player.

The Aspect Controller can control the Presentation Engine and set an aspect such as 4:3 or 16:9. In addition, the Resolution Controller can control the Presentation Engine and set 480 pixels, 720 pixels, or 1080 pixels per line. Further, the Audio Controller can set an audio system (such as PCM, Dorby, or MPEG systems) in which the number of output channels, main audio, and sub audio are supported. In addition, the HDMI Controller can set up conversion or down conversion of image data.

In contrast, in the case where output setting information of any of aspect, resolution, and audio is changed in the middle of playback of advanced contents, the Replay Controller 132 sets the playback processing section to a playback state from an object start position of an object. The operations are as described in FIGS. 9, 10, and 11.

In addition, according to the embodiment of FIG. 9, when a playback state from an object start position is set, the Replay Controller 132 starts from reading of a disk identification data file (DISCID.DAT) under a disc directory. In addition, according to the embodiment of FIG. 10, the Replay Controller 132 reads a play list, and then, sets a playback state when the playback state from the object start position is set.

A configuration for setting an output environment is constructed utilizing system parameters of a system parameter memory (nonvolatile memory) 140, for example. A description will be given later with respect to information such as system parameters.

Further, in this system, a Graphic Interface Controller (GUI Controller) 141 may be provided.

The GUI controller can display a comment to a user via a display in the case where the user has made an operation of changing an output environment. This operation will be described later.

As described above, with respect to advanced contents, the provider is allowed to make the following designs. That is, (1) applications and contents per se may be prepared, respectively, according to resolution. (2) Applications and contents per se may be prepared, respectively, according to an aspect. (3) Applications and contents per se may be prepared, respectively, according to a voice output environment. (4) Applications and contents per se may be prepared, respectively, according to use of the HDMI. Therefore, if resolution or the like is changed in the middle of playback, it is not compensated that an application compatible to that resolution is properly enabled. In order to make such compensation, in this apparatus, in the case where an output environment is changed in the middle of playback, replay control is carried out.

<Subsequently, a Description Will be Given with Respect to an Advanced Content Player>

<Data Access Manager>

A Data Access Manager is composed of a Disc Manager, a Network Manager, and a Persistent Storage Manager. A Data Access Manager 111 is responsible for exchange of a various types of data between a Data Source and an internal module of an Advanced Content Player.

A Data Cache 112 is a temporary data storage for playback advanced contents.

Persistent Storage Manager: A Persistent Storage Manager controls exchange of data between a persistent storage device and a module inside an advanced content player. The Persistent Storage Manager is responsible for provision of a file access API set relevant to the Persistent Storage Device. The Persistent Storage Device can support a file read/write function.

Network Manager: A Network Manager controls exchange of data between a Network Server and a module inside an Advanced Content Player. The Network Manager is responsible for provision of a file access API set relevant to the Network Server. The Network Server can generally support file downloading and support file uploading, depending on the Network Server. A Navigation Manager can execute file downloading/uploading between the Network Server and a File Cache in accordance with Advanced Navigation. In addition, the Network Manager can also provide an access function at a protocol level with respect to a Presentation Engine. A Secondary Video Player in the Presentation Engine can utilize these API sets for streaming from the Network Server.

<Data Cache>

A Data Cache has two types of temporary data storages. One is a File Cache that is a temporary buffer for file data. The other is a Streaming Buffer that is a temporary buffer for streaming data. Allocation of streaming data in the Data Cache is described in “playlist00.xml”, and is divided using a startup sequence for advanced content playback. The size of the Data Cache is 64 MB at minimum and is undefined at maximum.

Data Cache Initialization: A configuration of the Data Cache is changed using the startup sequence for advanced content playback. The size of the Streaming Buffer can be described in “playlist00.xml”. In the case where there is no description of the Streaming Buffer size, it denotes that the size of the Streaming Buffer is zero. The byte number of the Streaming Buffer size is calculated as follows.

<streamingBuf size=“1024”/>

Streaming Buffer size=1024×2 (KByte)=2048 (KByte)

The Streaming Buffer is zero byte at minimum and is undefined at maximum.

File Cache: A File Cache is used as a temporary file cache between Data sources or a Navigation Engine and a Presentation Engine. Advanced content files such as graphics images, effect sounds, texts, and fonts need to be stored in the File Cache before access from the Navigation Manager or an Advanced Navigation Engine.

Streaming Buffer: A Streaming Buffer is used as a temporary data buffer for a Secondary Video Set by means of a Secondary Video Playback Engine of a Secondary Video Player.

The Secondary Video Player requests the Network Manager to acquire part of a Secondary Video Set S-EVOB in the Streaming Buffer. The Secondary Video Player reads the S-EVOB data from the Streaming Buffer, and then, provides the read data to a Demultiplexer Module (Demux) of the Secondary Video Player.

<Navigation Manager>

A Navigation Manager 113 is responsible for control of all functional modules of the advanced Content Player in accordance with the description in the Advanced Navigation.

The Navigation Manager is mainly composed of two types of functional modules, an Advanced Navigation Engine and a File Cache Manager.

Advanced Navigation Engine: An Advanced Navigation Engine controls all of reproducing operations of advanced contents and controls an Advanced Presentation Engine in accordance with the Advanced Navigation. The Advanced Navigation Engine includes a Parser, a Declarative Engine, and a Programming Engine.

Parser: A Parser reads advanced navigation files and analyzes the syntax thereof. A result of the analysis is sent to proper modules, the declarative engine and the programming engine.

Declarative Engine: A declarative engine manages and controls operations whose advanced contents are declared, in accordance with the Advanced Navigation. The Declarative Engine carries out the following processing operations, namely:
The Declarative Engine makes controls of the Advanced Presentation Engine. Namely, it carries out:
Layout of a graphics object and an advanced text;
Styling of a graphics object and an advanced text; and
Timing control of a scheduled graphics plane operation and effect sound playback, and the like.
The Declarative Engine makes control of a Primary Video Player. Namely, it carries out:
Configuring a Primary Video Set including registry of a title playback sequence (Title Time Line); and
Control of a high-level player.
The Declarative Engine makes control of a Secondary Video Player. Namely, it carries out:
Configuring a Secondary Video Set; and
Control of a high-level player, and the like.

Programming Engine: A Programming Engine manages event driven behaviors, API (application Interface) set call, or all advanced contents. A user interface event is generally handled by the Programming Engine, and thus, an operation of the Advanced Navigation defined by the Declarative Engine may be changed.

File Cache Manager: A File Cache Manager carries out the following processing operations:
Providing files archived in an advanced stream of P-EVOBS from a demultiplexer module of the Primary Video Player;
Providing the Network Server or Persistent Storage with archived files;
Managing a survival period of files in the File Cache; and
Acquiring a file in the case where the file requested from the Advanced Navigation or the Presentation Engine has not been stored in the File Cache.

The above File Cache Manager is composed of an ADV_PCK buffer and a file extractor.

ADV_PCK Buffer: A File Cache Manager receives PCK of the advanced stream archived in P-EVOBS-TY2 from a demultiplexer module of a Primary Video Player. A PS header of the advanced stream PCK is erased, and basic data is stored in an ADV_PCK Buffer. In addition, the File Cache Manager acquires again an advanced stream file of the Network Server or Persistent Storage.

File Extractor: A File Extractor extracts an archived file from an advanced stream into an ADV_PCK buffer. The thus extracted file is stored in the File Cache.

<Presentation Engine>

A Presentation Engine 115 is responsible for playback of materials for presentation such as Advanced Elements, a Primary Video Set, and a Secondary Video Set.

The Presentation Engine decodes presentation data, and outputs an AV Renderer using a navigation command from the Navigation Engine. The Presentation Engine includes four types of modules, an Advanced Element Presentation Engine, a Secondary Video Player, a Primary Video Player, and a Decoder Engine.

Advanced Element Presentation Engine: An Advanced Element Presentation Engine outputs two types of presentation streams to an AV Renderer. One is a frame image of a graphics plane and the other is an effect sound stream. The Advanced Element Presentation Engine is composed of a Sound Decoder, a Graphics Decoder, a Text/Font Rasterizer or a Font Rendering System, and a Layout Manager.

Sound Decoder: A Sound Decoder reads a WAV file from a File Cache, and then, outputs LPCN data to an AV Renderer started up by the Navigation Engine.

Graphics Decoder: A Graphics Decoder acquires graphics data such as a PNG image or a JPEG image from a File Cache. These image files are decoded, and then, the decoded image files are sent to a Layout Manager upon request from the Layout Manager.

Text/Font Rasterizer: A Text/Font Rasterizer acquires font data from a File Cache, and then, generates a text image. In addition, this Rasterizer receives text data from a Navigation Manager or the File Cache. The text image is generated, and then, the generated text image is sent to the Layout Manager upon request from the Layout Manager.

Layout Manager: A Layout Manager produces a frame image of a graphics plane with respect to an AV Renderer. When the frame image is changed, layout information is sent from a Navigation Manager. The Layout Manager calls a graphics decoder, and then, decodes a specific graphics object set on the frame image. In addition, the Layout Manager calls a Text/Font Rasterizer, and then, produces a specific text object set on the frame image similarly. The Layout Manager locates a graphical image from a bottom layer to an appropriate place, and then, calculates a pixel value in the case where an object has an alpha channel or a value. Lastly, the frame image is sent to the AV Renderer.

Advanced Subtitle Player: An Advanced Subtitle Player includes a Timing Engine and a Layout Engine.

Font Rendering System: A Font Rendering System has a Font Engine, a Scaler, an Alphamap Generation, and a Font Cache.

Secondary Video Player: A Secondary Video Player plays subsidiary video contents, subsidiary audios, and subsidiary subtitles. These subsidiary presentation contents are generally stored in a disc, a network, and a persistent storage. In the case where contents are stored in the disc and not stored in a File Cache, an access cannot be provided from the Secondary Video Player. In the case of an access from a Network Server, it is necessary to immediately store contents in a Streaming Buffer before they are provided to a demultiplexer/decoder and avoid a data loss due to a bit rate change in a network transfer path. The Secondary Video Player is composed of a Secondary Video Playback Engine and a Demultiplexer Secondary Video Player. The Secondary Video Player is connected to an appropriate decoder of a Decoder Engine in accordance with a stream type of the Secondary Video Set.

Since two audio streams cannot be simultaneously stored in the Secondary Video Set, only one audio decoder is always connected to the Secondary Video Player.

Secondary Video Playback Engine: A Secondary Video Playback Engine controls all functional modules of a Secondary Video Player upon request from a Navigation Manager. The Secondary Video Playback Engine reads and analyzes a TMAP file, and grasps an appropriate read position of S-EVOB.

Demultiplexer (Dmux): A Demultiplexer reads an S-EVOB stream, and then, sends the read stream to a decoder connected to the Secondary Video Player. In addition, the Demultiplexer outputs PCK of S-EVOB at an SCR timing. In the case where S-EVOB is composed of any one stream of videos, audios, and advanced subtitles, the demultiplexer provides it to the decoder at an appropriate SCR timing.

Primary Video Player: A Primary Video Player plays a Primary Video Set. The Primary Video Set must be stored in a disc. The Primary Video Player is composed of a DVD Playback Engine and a Demultiplexer. The Primary Video Player is connected to an appropriate decoder of a Decoder Engine in accordance with a stream type of a Primary Video Set. In addition, playback of standard contents is executed in accordance with an operating mode.

DVD Playback Engine: A DVD Playback Engine controls all of functional modules of a Primary Video Player upon request from a Navigation Manager. The DVD Playback Engine reads and analyzes IFO and TMAP and controls special playback functions for a Primary Video Set such as grasping of an appropriate read position of P-EVOBS-TY2, multi-angle or audio/sub-picture selection, and sub video/audio playback.

Demux: A Demultiplexer reads P-EVOBS-TY2 in a DVD Playback Engine, and sends it to an appropriate decoder connected to a Primary Video Set. In addition, the Demultiplexer outputs each PCK of P-EVOB-TY2 to each decoder at an appropriate SCR timing. In the case of a multi-angle stream, an appropriate interleaved block of P-EVOB-TY2 on a disc is read in accordance with positional information of TMAP or Navigation Pack (N_PCK). The Demultiplexer provides an appropriate number of an audio pack (A_PCK) to a Main Audio Decoder or a Sub Audio Decoder and provides an appropriate number of a sub-picture pack (SP_PCK) to an SP Decoder.

Decoder Engine: A Decoder Engine consists of six types of decoders, i.e., a timed text decoder, a sub-picture decoder, a sub audio decoder, a sub video decoder, a main audio decoder, and a main video decoder. Each decoder is controlled by means of a playback engine of a connected player.

Timed Text Decoder: A Timed Text Decoder can be connected to only a demultiplexer module of a Secondary Video Player. This Decoder decodes an advanced subtitle of a format based on the timed text upon request from a DVD Playback Engine. One decoder can be made active at the same time between the Timed Text Decoder and the Sub-Picture Decoder. An output graphics plane is called a sub-picture plane, and is shared by outputs from the Timed Text Decoder and the Sub-Picture Decoder.

Sub Picture Decoder: A Sub-Picture Decoder can be connected to a demultiplexer module of a Primary Video Player. Sub-Picture data is decoded upon request from the DVD Playback Engine. One decoder can be made active at the same time between the Timed Text Decoder and the Sub-Picture Decoder. An output graphics plane is called a sub-picture plane, and is shared by outputs from the Timed Text Decoder and the Sub-Picture Decoder.

Sub Audio Decoder: A Sub Audio Decoder can be connected to demultiplexer modules of a Primary Video Player and a Secondary Video Player. The Sub Audio Decoder can support audios up to 2 channels and a sampling rate up to 48 kHz. This is called a sub audio. The sub audio is supported as a sub audio stream of the Primary Video Set, a stream of only audio of the Secondary Video Set, and further, an audio/video multiplexer stream of the Secondary Video Set. An output audio stream of the Sub Audio Decoder is called a sub audio stream.

Sub Video Decoder: A Sub Video Decoder can be connected to demultiplexer modules of a Primary Video Player and a Secondary Video Player. The Sub Video Decoder can support an SD resolution video stream called a sub video (maximum support resolution in preparation). The sub video is supported as a video stream of the Secondary Video Set and as a sub video stream of the Primary Video Set. An output video plane of the sub video decoder is called a sub video plane.

Main Audio Decoder: A Primary Audio Decoder can be connected to demultiplexer modules of a Primary Video Player and a Secondary Video Player. The Primary Audio Decoder can support an audio up to 7.1 multi-channels and a sampling rate up to 96 kHz. This is called a main audio. The main audio is supported as a main audio stream of the Primary Video set and as a stream of an only audio of the Secondary Video Set. An output audio stream of the main audio decoder is called a main audio stream.

Main Video Decoder: A Main Video Decoder is connected to only a demultiplexer of a Primary Video Player. The Main Video Decoder can support an HD resolution video stream. This is called a support main video. The main video is supported only in the Primary Video Set. An output video plane of the Main Video Decoder is called a main video plane.

<AV Renderer> An AV Renderer 116 is responsible for mixing of video/audio inputs from another module and speaker or display output to an external device.

The AV Renderer has two roles. One is a Presentation Engine and the other is an Interface Manager. Further, this Manager acquires a graphics plane from an output mixing video signal and acquires a PCM stream from a Presentation Engine and an output mixing audio signal. The AV Renderer is composed of a Graphic Rendering Engine and a Sound Mixing Engine.

Graphic Rendering Engine: A Graphic Rendering Engine acquires four graphics planes from a Presentation Engine and one graphics frame from a User Interface. The Graphics Rendering Engine combines these five planes with each other in accordance with control information acquired from a Navigation Manager, and then, outputs the thus combined video signals.

Audio Mixing Engine: An Audio Mixing Engine can acquire three LPCM streams from a Presentation Engine. A Sound Mixing Engine combines these three LPCM streams with one another in accordance with mixing level information acquired from a Navigation Manager, and then, outputs the combined audio signals.

<User Interface Manager>

A User Interface Manager 114 is responsible for control of a user interface device such as a remote controller or a front panel of an HD DVD player, and notifies a user entry event to a Navigation Manager 113.

The User Interface Manager, as shown in FIG. 14, includes a Font Panel Controller, a Remote Control Controller, a Keyboard Controller, a Mouse Controller, and a Game Pad Controller. Further, this Manager includes Device Controller of some user interfaces such as a Cursor Controller. Each controller checks whether or not a device is available and monitors a user-operated event. The user input event is notified to an event handler of a Navigation Manager.

The Cursor Manager controls a shape and a position of a cursor. A cursor plane is updated in accordance with a move event from an associated device such as a mouse or a game panel.

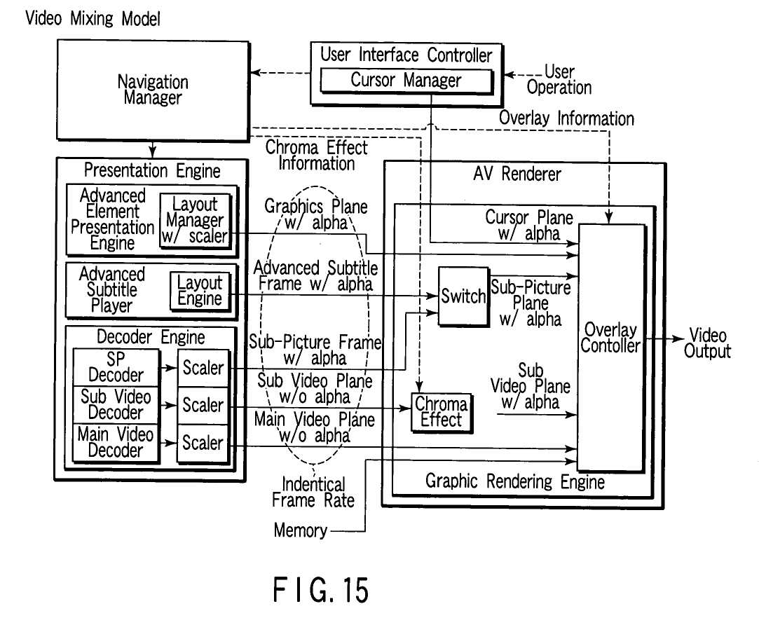

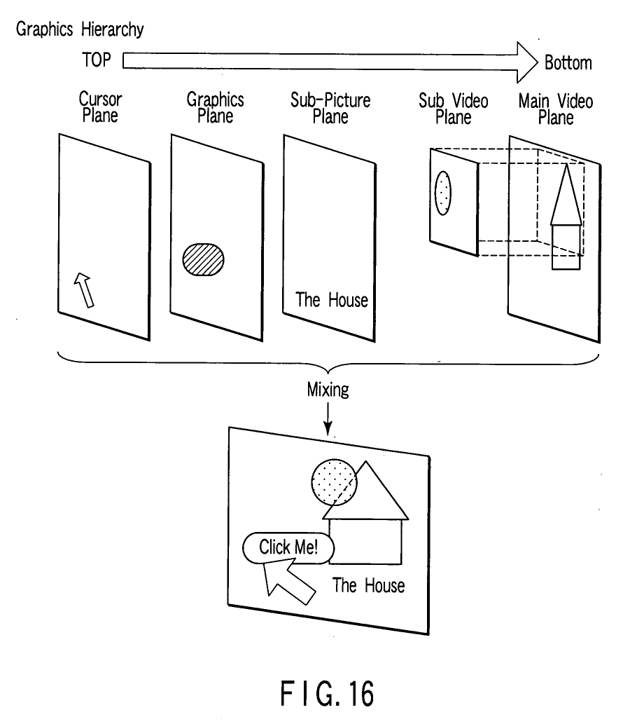

Video Mixing Model and Graphics Plane: A video-mixing model is shown in FIG. 15, and hierarchy of a graphics plane is shown in FIG. 16.

Five graphics can be inputted to this model shown in FIG. 15. These graphics are a Cursor Plane, a Graphics Plane, a Sub-Picture Plane, a Sub Video Plane, and a Main Video Plane.

Cursor Plane: A Cursor Plane is a top-layered plane among five graphics that are inputs to a Graphics Rendering Engine at the model. The Cursor Plane is generated by means of a Cursor Manager of the User Interface Manager. The Navigation Manager can replace the Cursor Image in accordance with Advanced Navigation. The Cursor Manager moves a cursor to an appropriate position of the Cursor Plane, and then, updates the moved cursor with respect to the Graphics Rendering Engine. The Graphics Rendering Engine acquires its cursor plane and alpha mix, and then, lowers a plane in accordance with alpha information acquired from the Navigation Engine.

Graphics Plane: A Graphics Plane is a second plane among the five graphics that are inputs to the Graphics Rendering Engine at the model. The Graphics Plane is generated by means of an Advanced Element Presentation Engine in accordance with the Navigation Engine. A Layout Manager produces a Graphics Plane by using a Graphics Decoder and a Text/Font Rasterizer. The size and rate of an output frame must be equal to those of a video output of this model. An animation effect can be realized by means of a series of graphics images (cell animation). Alpha information relevant to the plane is not provided from a Navigation Manager of an overlay controller. These values are provided to an alpha channel of a Graphics Plane per se.

Sub-Picture Plane: A Sub-Picture Plane is a third plane among the five graphics that are inputs to the Graphics Rendering Engine at the model. The Sub-Picture Plane is generated by means of a Timed Text Decoder or a Sub-Picture Decoder of a Decoder Engine. In a Primary Video Set, a set of appropriate sub-picture images can be inputted in output frame size. In the case where an appropriate size of an SP image is identified, an SP Decoder directly transmits the generated frame image to the Graphics Rendering Engine. In the case where the appropriate size of the SP image is not identified, a Scaler that follows the SP Decoder measures the appropriate size and position of the frame image, and then, transmits the measurement to the Graphics Rendering Engine.

A Secondary Video Set can enter an advanced subtitle for the Timed Text Decoder. Output data from the Sub-Picture decoder holds alpha channel information.

Sub Video Plane: A Sub Video Plane is a fourth plane among the five graphics that are inputs to the Graphics Rendering Engine at the model. The Sub Video Plane is generated by means of a Sub Video Decoder of a Decoder Engine. The Sub Video Plane is measured by means of a Scaler of the Decoder Engine in accordance with information acquired from a Navigation Manager. An output frame rate must be equal to that of a final video output. Cutting of an object shape of the Sub Video Plane is carried out by means of a chroma effect module of the Graphics Rendering Engine as long as information is provided. Chroma color (or range) information is provided from the Navigation Manager in accordance with Advanced Navigation. An output plane from the chroma effect module has two alpha values. One is 100%-visible and the other is 100%-transparent. With respect to overlay on a bottom-layered Main Video Plane, an intermediate alpha value is provided from the Navigation Manager, and then, such overlay is carried out by means of an overlay control module of the Graphics Rendering Engine.

Main Video Plane: A Main Video Plane is a bottom-layered plane among the five graphics that are inputs to the Graphics Rendering Engine at the model. The Main Video Plane is generated by means of a Main Video Decoder of a Decoder Engine. The Main Video Plane is measured by means of a Scaler of a Decoder Engine in accordance with information acquired from a Navigation Manager. An output frame rate must be equal to that of a final video output. In the case where the Navigation Manager carries out measurement in accordance with Advanced Navigation, an outside frame color can be set for the Main Video Plane. A default color value of the outside frame is “0, 0, 0” (=black).

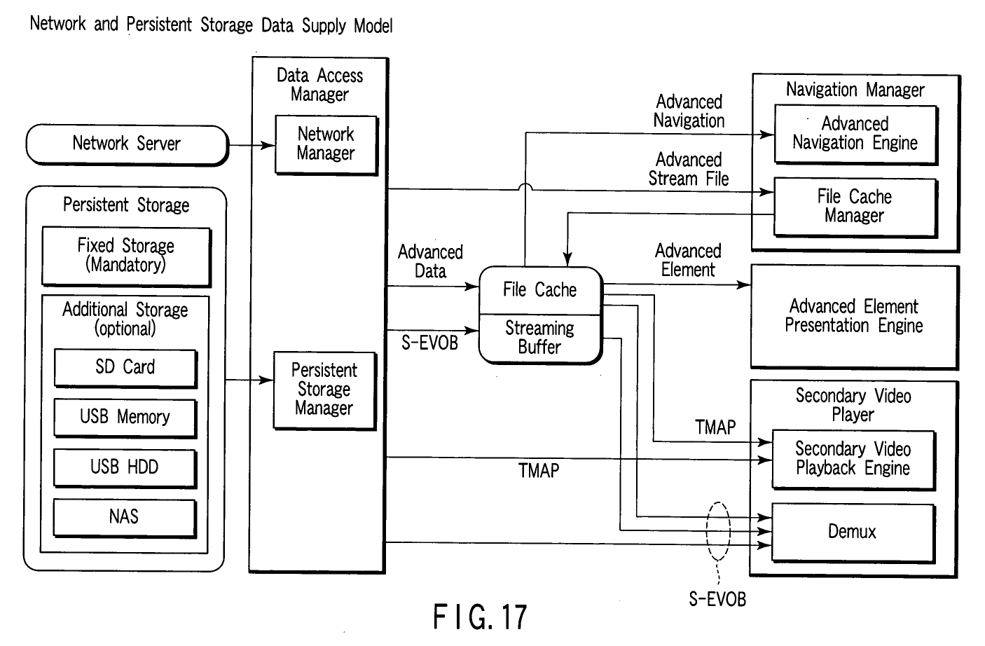

As described above, in the Advanced Player, in accordance with object mapping of a play list, an object selected by a video audio clip and included in this clip is played back while a timeline is defined as a time base. Namely, in the case where a first application includes Primary/Secondary Video Sets or the like in accordance with a description of a play list, this application is executed while referring thereto. One application is composed of a manifest, a markup (including contents/styling/timing information), a script, and advanced data. A first one markup file, a script file, and other resources, which configure an application, are referenced in one manifest file. By means of a markup, playback of advanced data such as primary/secondary video sets and advanced elements is started.

<Network and Persistent Storage Data Supply Model (FIG. 17)>

A Network and Persistent Storage Data Supply Model of FIG. 17 represents a data supply model of advanced contents from a network server and a persistent storage.

The Network and Persistent Storage can store all of advanced content files other than a Primary Video Set. The Network Manager and the Persistent Storage Manager each provide a file access function. In addition, the Network Manager also provides an access function at a protocol level.

A File Cache Manager of a Navigation Manager can acquire an advanced stream file (archive format) directly from the Network Server and the Persistent Storage via a Network Manager and a Persistent Storage Manager. The Advanced Navigation Engine cannot directly access the Network Server or the Persistent Storage. Files must be immediately stored in a File Cache before the Advanced Navigation Engine reads them.

The Advanced Element Presentation Engine can process a file that exists in the Network Server or the Persistent Storage. The Advanced Element Presentation Engine calls a File Cache Manager, and then, acquires a file that it not placed in the File Cache. The File Cache Manager is compared with a File Cache Table to check whether or not a requested file is cached in the File Cache. In the case where the file has exited in the File Cache, the File Cache Manager directly posts the file data to the Advanced Presentation Engine. In the case where the file has not existed in the File Cache, the File Cache Manager acquires a file from an original place to the File Cache, and then, posts the file data to the Advanced Presentation Engine.

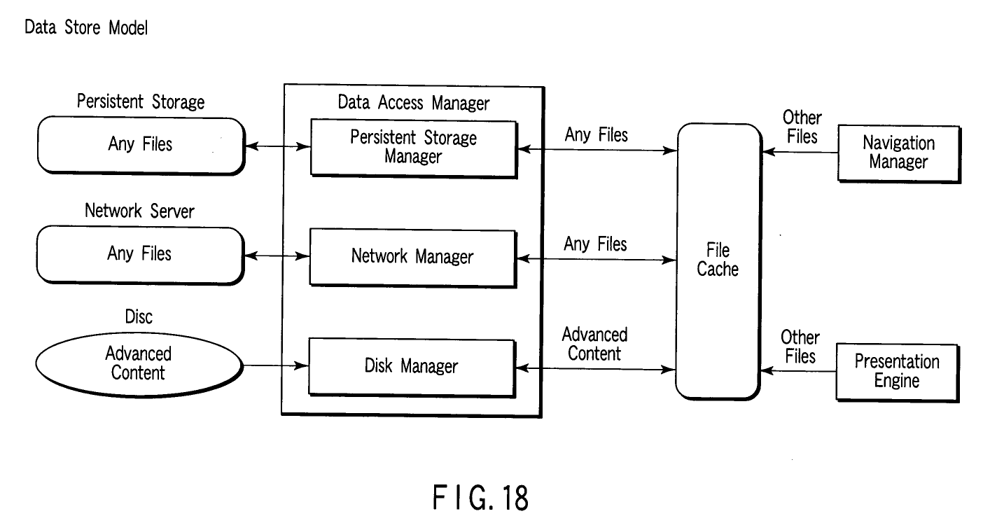

A Secondary Video Player acquires a secondary video set file such as TMAP or S-EVOB from a Network Server and a Persistent Storage via a Network Manager and a Persistent Storage Manager, as is the case with the File Cache. In general, a Secondary Video Playback Engine acquires S-EVOB from a Network Server by using a streaming buffer. Immediately, part of S-EVOB data is stored in a streaming buffer, and is provided to a demultiplexer module of the Secondary Video Player.

<Data Store Model (FIG. 18)>

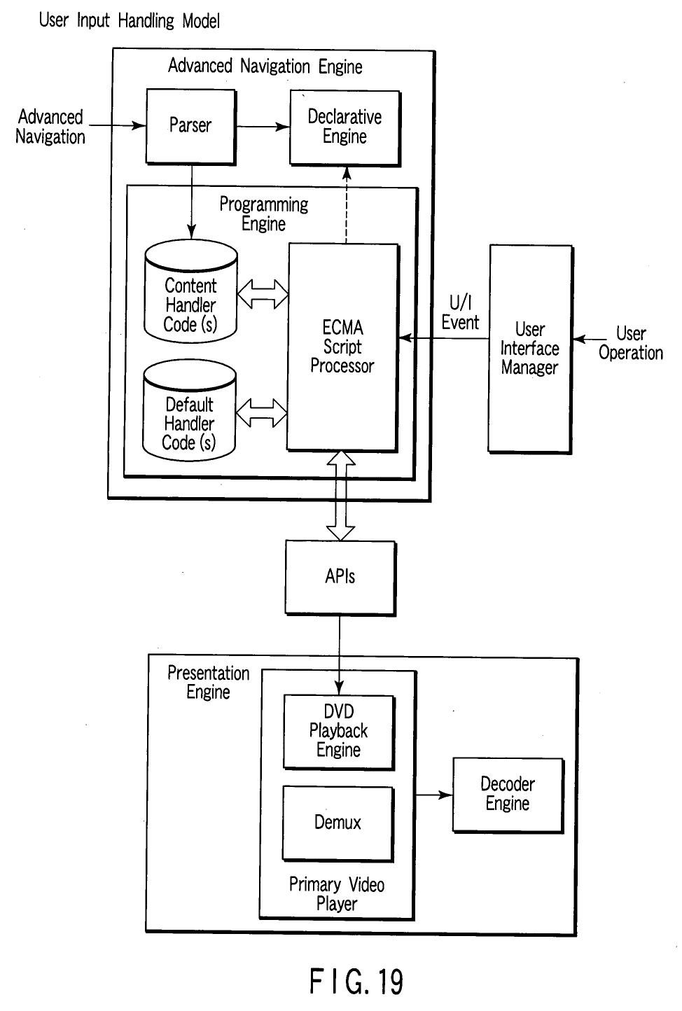

FIG. 18 explains a Data Store Model. There are two types of data storages, i.e., Persistent Storage and a Network Server. Two types of files are generated at the time of advanced content playback. One is a file of an exclusive type that is generated by means of a Programming Engine of a Navigation Manager. A format is different from another format depending on a description of the Programming Engine. The other file is an image file that is acquired by means of a Presentation Engine.

<User Input Model (FIG. 19)>

All of user input events shown in FIG. 19 are handled by means of a Programming Engine. A user operation via a user interface device such as a remote controller or a front panel is first inputted to a User Interface Manager. The User Interface Manager converts input signals for each player into an event defined as “UIIEvent” of “InterfaceRemoteControllerEvent”. The converted user input event is transmitted to a Programming Engine.

The Programming Engine has an ECMA Script Processor, and executes a programmable operation. The programmable operation is defined by means of a description of an ECMA Script provided by a Script File of Advanced Navigation. The user event handler code defined in a script file is registered in the Programming Engine.

When the ECMA script processor receives a user input event, the ECMA script processor checks whether or not the handler code corresponds to a current event registered in a content handler code. In the case where registration occurs, the ECMA script processor executes it. In the case where no registration occurs, the ECMA script processor makes a search for a default handler code. In the case where the corresponding default handler code exists, the ECMA script processor executes it. In the case where it does not exist, the ECMA script processor cancels that event or outputs a warning signal.

<Presentation Timing Model>

An Advanced Content Presentation is managed by a master time for defining a synchronization relationship between a presentation schedule and a presentation object. The master time is called a title timeline. This title timeline is defined for each logical playback time, and the defined timeline is called a title. A timing unit of the title timeline is 90 kHz. There are five types of presentation objects, i.e., a Primary Video Set (PVS), a Secondary Video Set (SVS), a Subsidiary Audio, a Subsidiary Subtitle, and an Advanced Application (ADV_APP).

<Presentation Object>

Five types of presentation objects are as follows:
Primary Video Set (PVS)
Secondary Video Set (SVS)
Sub Video/Sub Audio
Sub Video
Sub Audio
Subsidiary Audio (for Primary Video Set)
Subsidiary Subtitle (for Primary Video Set)
Advanced Application (ADV_APP)

<Attributes of Presentation Object>

A Presentation Object has two types of attributes. One is “an object that is scheduled or not scheduled” and the other is “an object that is synchronized or not synchronized”.

<Scheduled and Synchronized Presentation Object>

Start and end times of this object type are allocated in advance to a play list file. A Presentation Timing is synchronized with a time of a Title Timeline. A Primary Video Set, a Subsidiary Audio, and a Subsidiary Subtitle are of this object type. A Secondary Video Set and an Advanced Application are handled as this object type.

<Scheduled and Non-Synchronized Presentation Object>

The start and end times of this object type are allocated in advance to a play list file. A presentation timing is a time base of its own. A Secondary Video Set and an Advanced Application are handed as this object type.

<Non-Scheduled and Synchronized Presentation Object>

This object type is not described in a play list file. This object is started up by a user event handled by an Advanced Application. A presentation timing is synchronized on a title timeline.

<Non-Scheduled and Non-Synchronized Presentation Object>

This object type is not described in a play list file. This object is started up by a user event handled by an Advanced Application. A presentation timing is a time base of its own.

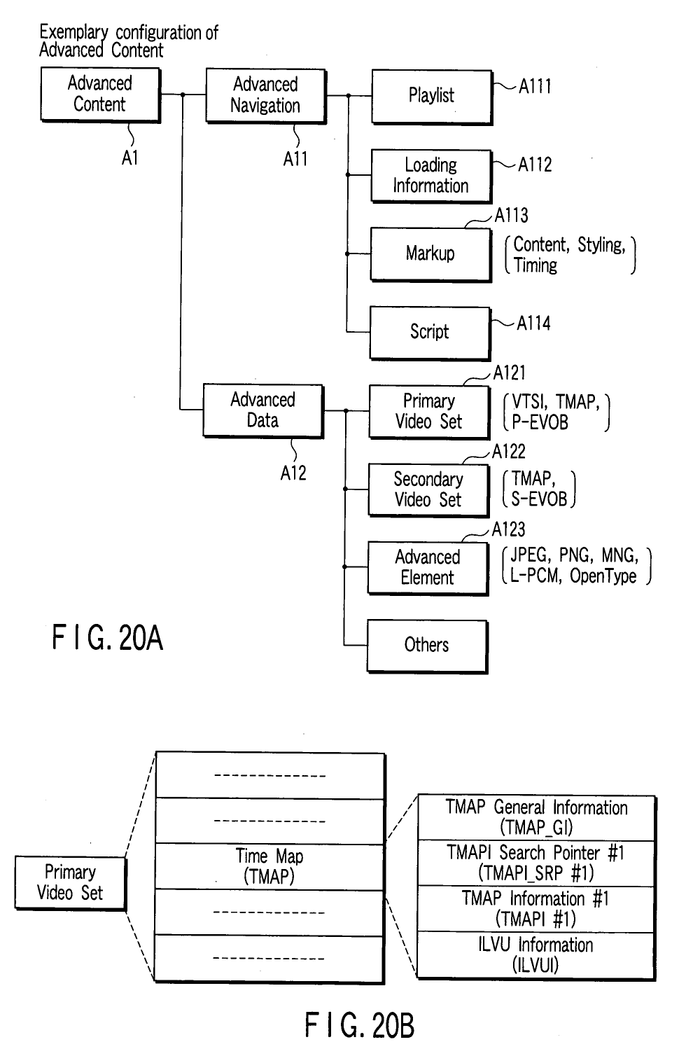

FIGS. 20A and 20B are a diagram to help explain an exemplary configuration of an Advanced Content stored in an advanced content recording region of an information storage medium. The Advanced Content does not always need to be stored in the information storage medium, and, for example, may be provided from a server via a network.

As shown in FIG. 20A, the Advanced Content recorded in an advanced content area A1 is configured to include: an Advanced Navigation for managing Primary/Secondary Video Set outputs, test/graphic rendering, and an audio output; and Advanced Data made of these items of data managed by the Advanced Navigation. The Advanced Navigation recorded in an advanced navigation area A11 includes: Play list files, Loading Information files, Markup files for content, styling, and timing information; and Script files. The Play list files are recorded in a play list files area A111. Loading information files are recorded in a loading information files area A112. The Markup files are recorded in a markup files area A113. The Script files are recorded in a script files area A114.

The Advanced Data recorded in an advanced data area A12 includes: a Primary Video Set including object data (VTSI, TMAP, and P-EVOB); a Secondary Video Set including object data (TMAP and S-EVOB); and Advanced Elements (such as JPEG, PNG, MNG, L-PCM, OpenType font) and others. In addition, the Advanced Data also includes object data that configures a menu (screen) in addition to the above described elements. For example, the object data included in the Advanced Data is played back within a designated period on a timeline by means of a time map (TMAP) of a format shown in FIG. 20B. The Primary Video Set is recorded in a primary video set area A121. The Secondary Video Set is recorded in a secondary video set area A122. The Advanced Elements are recorded in an advanced element area A123.

The Advanced Navigation includes: play list files, loading information files, markup files for content, styling, and timing information, and script files. These files (play list files, loading information files, markup files, and scrip files) are encoded as an XML document. A resource of an XML document for the Advanced Navigation is rejected by means of an Advanced Navigation Engine when it is not described in a correct format.

While the XML document becomes valid in accordance with definition of a document type provided as standard, the Advanced Navigation Engine (at the player side) does not necessarily need a function of judging validity of the content (provider may guarantee the validity of the content.) When the resource of the XML document is not described in a correct format, normal operation of the Advanced Navigation Engine is not guaranteed.

Following rules are applied to XML declaration:
Encode declaration is “UTF-8” or “ISO-8859-1”. An XML file is encoded by means of either of them.
A value of standard document declaration in the XML declarations is set to “no” when this standard document declaration exists. When the standard document declaration does not exist, this value is handled as “no”.

All resources available on a disc or over a network have addresses encoded by a Uniform Resource Identifier defined by [URI, RFC2396].

A protocol and a path supported for a DVD disc are as follows, for example:

file://dvdrom:/dvd_advnav/file.xml

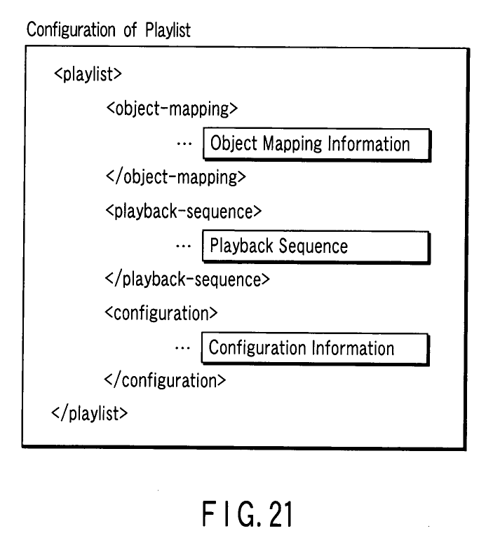

FIG. 20B shows an exemplary configuration of a time map (TMAP). This time map is used to convert a playback time in a primary enhanced video object (F-EVOB) to an address of the corresponding enhanced video object unit (EVOBU). The inside of TMAP comprising time map information (TMAPI) starts from TMAP General Information (TMAP_GI) followed by TMAPI Search Pointer (TMAPI_SRP) and TMAP Information (TMAPI), and finally, ILVU Information (ILVUI) is allocated.

<Playlist File (FIG. 21)>

A Playlist file has two purposes of use relevant to advanced content playback. One is for initial system configuration of an HD DVD player and the other is for defining a method for playing a plurality of presentation contents of advanced contents.

In the Playlist file, as exemplified in FIG. 21, sets of Object Mapping Information and Playback Sequences for titles are described on a title by title basis.
Object Mapping Information (Playback object information that exists in each title and is mapped on a timeline of this title);
Playback Sequence (playback information for each title described by a title timeline); and
Configuration Information (System configuration information such as data buffer alignment).

This Playlist file is encoded in an XML format. The syntax of the Playlist file can be defined by means of XML Syntax Representation.

This Playlist file controls playback of a menu and a title composed of a plurality of objects, based on a time map for playing back the plurality of objects within a designated period on a timeline. This Playlist enables playback of a dynamic menu.

According to a menu linked with the time map, dynamic information can be transmitted to a user. For example, a reduced playback screen (mobile picture) of chapters each configuring one title can be displayed on the menu linked with the time map, for example. In this manner, discrimination of chapters each configuring one title including a number of similar scenes is comparatively facilitated. Namely, according to the menu linked with the time map, multi-angled displays are enabled, and a complicated impressive menu display can be realized.

<Elements and Attributes>

A Play list element is a root element of that play list. XML syntax representation of the Playlist element is as follows, for example:

<Play list>
Configuration TitleSet
</Play list>

The Play list element is composed of a Title Set element for a set of the information of Titles and a Configuration element for System Configuration Information. The Configuration element is composed of a set of System Configuration for Advanced Content. In addition, System Configuration Information can be composed of Data Cache configuration for specifying a stream buffer size or the like, for example.

The Title Set Element describes information of a set of Titles for Advanced Contents in the Play list. The XML Syntax Representation of the Title Set Element is as follows, for example.

<TitleSet>
Title*
</TitleSet>

The Title Set Element is composed of a list of Title elements. In accordance with a document sequence of title elements, Title numbers for the Advanced Navigation are assigned continuously sequentially from “1”. The Title Element is configured to describe information of each title.

That is, the Title Element describes information of Title for Advanced Contents configured to include object mapping information and playback sequences in a title. The XML Syntax Representation of the Title element is as follows, for example.

```
<Title
  id = ID
  hidden = (true | false)
  onExit = positiveInteger>
    Primary Video Track?
    SecondaryVideoTrack?
    SubstituteAudioTrack?
    ComplementarySubstituteTrack?
    ApplicationTrack*
    Chapter List?
</Title>
```

The content of the Title element is composed of an element fragment for tracks and a Chapter List element. Here, the element fragment for tracks is composed of: a list of elements of Primary Video Track; a Secondary Video Track; SubstituteAudio Track; a Complementary Subtitle Track; and an Application Track.

The Object Mapping Information for a Title is described by means of the element fragment for tracks. The mapping of a Presentation Object on a Title Timeline is described by mean of a corresponding element. Here, the Primary Video Set corresponds to the Primary Video Track; the Secondary Video Set corresponds to the Secondary Video Track; a SubstituteAudio corresponds to the SubstituteAudio Track; the Complementary Subtitle corresponds to the Complementary Subtitle Track; and ADV_APP corresponds to the Application Track.

The Title Timeline is assigned to each title. In addition, information of Playback Sequence for a Title made of chapter points is described by means of a Chapter List element.

Here, (a) hidden attribute can describe whether or not a title can be navigated by a user operation. If that value is “true”, that title cannot be navigated by the user operation. This value can be defaulted. In that case, the default value is set to “false”.

In addition, (b) on Exit attribute can describe a title played back after current title playback. When current title playback exists before the end of that title, a player can be configured not to carry out a (playback) jump.

A Primary Video Track element describes Object Mapping Information of the Primary Video Set in a title. The XML Syntax Representation of the Primary Video Track element is as follows, for example:

```
<Primary Video Track
  id = ID>
    (Clip | Clip Block) +
</Primary Video Track>
```

The content of the Primary Video Track is composed of a list of a Clip element and a Clip Block element, for referencing P-EVOB in the Primary Video as a Presentation Object. A player is configured to pre-assign P-EVOB(s) on a Title Timeline by using a start time and an end time in accordance with description of the Clip element. P-EVOB(s) assigned onto the Title Timeline are designed so as not to overlap each other.

The Secondary Video Track element describes Object Mapping Information of the Secondary Video Set in a title. The XML Syntax Representation of the Secondary Video Track element is as follows, for example:

```
<SecondaryVideoTrack
  id = ID
  sync = (true | false)>
    Clip +
</SecondaryVideoTrack>
```

The content of the Secondary Video Track is composed of a list of Clip elements, for referencing S-EVOB in the Secondary Video Set as a Presentation Object. A Player is configured so as to pre-assign S-EVOB(s) onto a Title Timeline by using a start time and an end time in accordance with description of the Clip element.

In addition, the Player is configured so as to map a Clip and the Clip Block onto the Time Timeline as start and end positions of a clip on the Title Timeline by means of a title Begin Time and a title End Time attribute of a clip element. S-EVOB(s) assigned onto the Title Timeline is designed so as not to overlap each other.

If a sync attribute is ‘true’, the Secondary Video Set is synchronized with a time on the Title Timeline. On the other hand, when the sync attribute is ‘false’, the Secondary Video Set can be configured to run in accordance with its own time. (In other words, when the sync attribute is ‘false’, playback proceeds in accordance with a time assigned to the Secondary Video Set per se instead of the time of the Timeline.)

Further, when a sync attribute value is ‘true’ or defaulted, the Presentation Object in the Secondary Video Track is obtained as a Synchronized Object. On the other hand, if the sync attribute value is ‘false’, the Presentation Object in the SecondaryVideoTrack is obtained as a Non-synchronized Object.

The SubstituteAudio Track element describes assignment to Audio Stream Number for the Object Mapping Information and Audio Stream Number of the Substitute Audio Track in a title. The XML Syntax Representation of the substitute audio track element is as follows, for example:

```
<SubstituteAudioTrack
  id = ID
  streamNumber = Number
    languageCode = token
    >
  Clip +
</SubstituteAudioTrack>
```

The content of the SubstituteAudioTrack element is composed of a list of clip elements, which refers to SubstituteAudio as a Presentation Element. A player is configured to pre-assign a SubstituteAudio onto a Title Timeline in accordance with description of the clip elements. The SubstituteAudios pre-assigned onto the Title Timeline is designed not to overlap each other.

A specified Audio Stream Number is assigned to the Substitute Audio. When Audio_stream_change API selects a specified stream number of the SubstituteAudio, the player is configured to select a SubstituteAudio instead of the audio stream in the Primary Video Set.

The audio stream number for this SubstituteAudio is described in a stream Number attribute.

A specific code and a specific code extension for this SubstituteAudio are described in a language Code attribute.

A language code attribute value conforms to the following scheme (BNF scheme). That is, the specific code and specific code extension describe a specific code and a specific code extension, respectively, and, for example, it follows:

languagecode :=specificCode ‘:2 ’ specificCodeExtension

specificCode := [A–Za–z] [A–Za–z0–9]
specificCodeExt := [0–9A–F] [0–9A–F]

A Complementary Substitute Track element describes the Object Mapping Information on the Complementary Subtitle in a title and assignment to Sub-picture Stream Number. The XML Syntax Representation of the Complementary Subtitle Track element is as follows, for example.

```
<ComplementarySubtitleTrack
  id = ID
  streamNumber = Number
    languageCode = token
    >
  Clip +
</ComplementarySubtitleTrack>
```

The content of the Complementary Subtitle Track element is composed of a list of clip elements, which refers to a Complementary Subtitle as a Presentation Element. A player is configured to pre-assign the Complementary Subtitle on a Title Timeline in accordance with description of the clip elements. Complementary Subtitle(s) assigned onto the Title Timeline are designed not to overlap each other.

A specified Sub-picture Stream Number is assigned to the Complementary Subtitle. When Sub-picture_stream_Change API selects a stream number of the Complementary Subtitle, the player is configured to select the Complementary Subtitle instead of a sub-picture stream in a Primary Video Set.

A Sub-picture Stream Number for this Complementary Subtitle is described in a stream Number attribute.

A specific code and a specific code extension for this Complementary Subtitle are described in a language code attribute.

A language code attribute value conforms to the following scheme (BNF scheme). That is, the specific code and specific code extension describe a specific code and a specific code extension, respectively, and, for example, it follows:

```
  languageCode := specificCode ‘:’
specificCodeExtension
  specificCode := [A–Za–z] [A–Za–z0–9]
  specificCodeExt := [0–9A–F] [0–9A–F]
```

An Application Track element describes object mapping information on ADV_APP in the title. An XML syntax representation of the Application Track element is, for example, as follows:

```
<ApplicationTrack
  id = ID
  loading_info = anyURI
  sync = (true | false)
  language = string />
```

Here, ADV_APP is scheduled on a whole Title Timeline. When a player starts title playback, the player launches ADV_APP in accordance with Loading Information file indicated by a loading information attribute. When the player exits the title playback, ADV_APP in a title is also terminated.

Here, if a sync attribute is ‘true’, ADV_APP is configured to be synchronized with a time on a Title Timeline. On the other hand, when the sync attribute is ‘false’, ADV_APP can be configured to run in accordance with its own time.

A loading information attribute describes URI for loading information files having described therein initialization information of the application.

With respect to a sync attribute, when the sync attribute value is ‘true’, it indicates that ADV_APP in ApplicationTrack is a Synchronized Object. On the other hand, if the sync attribute value is ‘false’, it indicates that ADV_APP in ApplicationTrack is a Non-synchronized Object.

A Clip Element describes information on a period (life period or from a start time to an end time) on a Title Timeline of a Presentation Object. The XML Syntax Representation of the Clip Element is as follows, for example:

```
  <Clip
    id = ID
    title Time Begin = time Expression
    clip Time Begin = time Expression
    title Time End = time Expression
    src = anyURI
    preload = time Expression
    xml:base = anyURI>
      (Unavailable Audio Stream |
Unavailable Sub picture Stream)*
    </Clip>
```

The life period on the Title Timeline of the Presentation Object is determined depending on a start time and an end time on the Title Timeline. The start time and end time on the Title Timeline can be described by a title Time Begin attribute and a title Time End attribute, respectively. A starting position of the Presentation Object is described by means of a clip Time Begin attribute. In the start time on the Title Timeline, the Presentation Object exists at a start position described by clip Time Begin.

The Presentation Object is referenced by means of URI of an index information file. A TMAP file for P-EVOB is referred to with respect to a Primary Video Set. A TMAP file for S-EVOB is referred to with respect to a Secondary Video Set. A TMAP file for S-EVOB of a Secondary Video Set including an Object is referred to with respect to a SubstituteAudio and a Complementary Subtitle.

Attribute values of a title Begin Time, a title End Time, clip Begin Time, and a duration time of a Presentation Object are configured to satisfy the following relationship:

```
  title Begin Time < title End Time and
  Clip Begin Time + title End Time − title
Begin Time
    ≦ duration time of Presentation
Object
```

An Unavailable Audio Stream and an Unavailable Sub picture Stream exist only for a Clip Element in a Preliminary Video Track element.

A title Time Begin attribute describes a start time of a continuous fragment of a Presentation Object on a Title Timeline.

A title Time End attribute describes an end time of a continuous fragment of a Presentation Object on a Title Timeline.

A clip Time Begin attribute describes a starting position in a Presentation Object, and the value thereof can be described in a time Expression value. The clip Time Begin can be defaulted. When the clip Time Begin attribute does not exist, the starting position is set to ‘0’, for example.

A “src” attribute describes URI of an index information file of a Presentation Object to be referred to.

A preload attribute can describe a time on a Title Timeline when starting playback of a Presentation Object pre-fetched by a player.

A Clip Block element describes a group of clips in P-EVOBS called a Clip Block. One clip is selected for playback. The XML Syntax Representation of the Clip Block element is as follows, for example:

<Clip Block>
Clip+
</Clip Block>

All clips in the Clip Block are configured so as to have the same start time and the same end time. From this fact, the Clip Block can be scheduled on a Title Timeline by using start and end times of the first child Clip. The Clip Block can be configured to be usable only in a Primary Video Track.

The Clip Block can express an Angle Block. In accordance with the document sequence of the Clip elements, Angle numbers for an Advanced Navigation are continuously assigned from “1”.

A player selects a first clip to be played back as a default. However, when Angle_Change API selects a specified Angle number, the player selects a clip corresponding thereto to be played back.

An Unavailable Audio Stream element in the clip element describing a Decoding Audio Stream in P-EVOBS is configured to be unavailable during a playback period of the clip. The XML Syntax Representation of the Unavailable Audio Stream element is as follows, for example:

```
<Unavailable Audio Stream
  number = integer
  />
```

The Unavailable Audio Stream element can be used only in a clip element for P-EVOB that exists in Primary Video Track elements. Otherwise, the Unavailable Audio Stream does not exist. In additions a player disables a Decoding Audio Stream indicated by a number attribute.

An Unavailable Sub picture Stream element in clip elements describing a Decoding Sub-picture Stream in P-EVOBS is configured so as to be unavailable during a playback period of the clip. The XML Syntax Representation of the Unavailable Sub picture Stream element is as follows, for example:

```
<Unavailable Sub picture Stream
  number = integer
  />
```

The Unavailable Sub picture Stream element can be used only in clip elements for P-EVOB that exists in Primary Video Track elements. Otherwise, the Unavailable Sub picture Stream element does not exist. In addition, a player disables a decoding sub picture stream indicated by a number attribute.

A Chapter List element in title elements describes playback sequence information for the title. Here, the playback sequence defines a chapter start position in accordance with a time value on a Title Timeline. The XML Syntax Representation of the Chapter List element is as follows, for example:

<Chapter List>
Chapter+
</Chapter List>

The Chapter List element is composed of a list of chapter elements. The Chapter element describes a chapter start position on the Title Timeline. In accordance with the document sequence of the chapter elements in the chapter list, chapter numbers for an Advanced Navigation are continuously assigned from ‘1’. That is, the chapter start position in the Title Timeline is configured to be monotonically increased in accordance with the chapter numbers.

The Chapter element describes a chapter start position on the Title Timeline in a Playback Sequence. The XML Syntax Representation of the Chapter element is as follows, for example:

```
  <Chapter
    id = ID
    title Begin Time = time
Expression/>
```

The Chapter element has a title Begin Time attribute. A time Expression value of this title Begin Time attribute describes a chapter start position on the Title Timeline.

The title Begin Time attribute describes a chapter start position on the Title Timeline in the Playback Sequence, and the value thereof is described in the time Expression value.

<Datatypes>

A time Expression describes a time code in positive integer in units of 90 kHz, for example.

[Loading Information File]

A Loading Information File is initialization information of ADV_APP for titles, and a player is configured to launch ADV_APP in accordance with the information contained in the loading information file. This ADV_APP has a configuration made of presentation of Markup file and execution of Script.

The initialization information described in the Loading Information File is as follows:
Files to be first stored in a File Cache before executing initial markup file;
Initial markup files to be executed; and
Script file to be executed.

The Loading Information File needs to be encoded in a correct XML format, and rules are applied to an XML document file.

<Element and Attributes>

The syntax of the Loading Information File is defined using XML Syntax Representation.

An Application element is a root element of the Loading Information File, and includes the following elements and attributes:

XML Syntax Representation of Application element

```
  <Application
    id = ID
    >
      Resource* Script? Markup?
Boundary?
  </Application>
```

A Resource element describes a file to be stored in a File Cache before executing initial Markup. The XML Syntax Representation of a Playlist element is as follows, for example*

```
<Resource
  id = ID
  src = anyURI
  />
```

Here, an “src” attribute describes URI for files to be stored in the File Cache.

A Script element describes an initial Script file for ADV_APP. The XML Syntax Representation of the Script element is as follows, for example:

```
<Script
  id = ID
  src = anyURI
  />
```

At the time of application startup, a Script Engine loads a Script File referred to by URI in the “src” attribute, and then, executes the loaded file as a global code [ECMA 10.2.10]. The “src” attribute describes URI for initial Script file.

The Markup element describes an initial markup file for ADV_APP. The XML Syntax Representation of the Markup element is as follows, for example:

```
<Markup
  id = ID
  src = anyURI
  />
```

If an initial Scrip file exists at the time of application start, after executing the startup, an Advanced Navigation is configured to load a Markup file by referring to URI in the “src” attribute. Here, the “src” attribute describes URI for initial markup file.

A Boundary element can be configured to describe valid URL that can be referenced by an application.

<Markup File>

A markup File is information of a Presentation Object on a Graphics Plane. Only one markup file can exist simultaneously in an application. The markup file is composed of a content model, styling, and timing.

<Script File>

A Script File describes a Script global code. A Script Engine is configured to execute a Script file at the time of startup of ADV_APP, and then, wait for an event in an event handler defined by the executed Script global code.

Here, Script is configured to control a Playback Sequence and a Graphics on the Graphics Plane in accordance with events such as a User Input Event or a Player playback event.

<Playlist File: Described in XML (Markup
Language)>

A reproducing apparatus (player) is configured to first playback a Playlist file (prior to Advanced Content playback) when a disc has the Advanced Content.

A Primary Video Set is configured to include Video Title Set Information (VTSI), Enhanced Video Object Set for Video Title Set (VTS_EVOBS), Backup of Video Title Set Information (VTSI_BUP), and Video Title Set Time Map Information (VTS_TMAPI).

Some of the following files can be maintained in an Archive without being compressed.

Manifest (XML)
Markup (XML)
Script (ECMAScript)
Image (JPEG/PNG/MNG)
Effect sound audio (WAV)
Font (OpenType)
Advanced Subtitle (XML)

In this standard, a file maintained in the Archive is called an advanced stream. This file can be stored in a disc (under an ADV_OBJ directory) or can be distributed from a server. In addition, this file is multiplexed in EVOB of a Primary Video Set. In this case, the file is divided into a pack called an advanced pack (ADV_PCK).

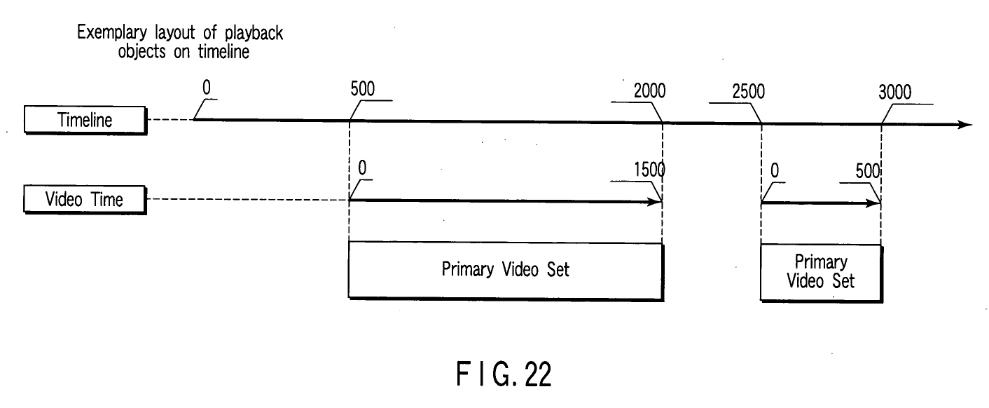

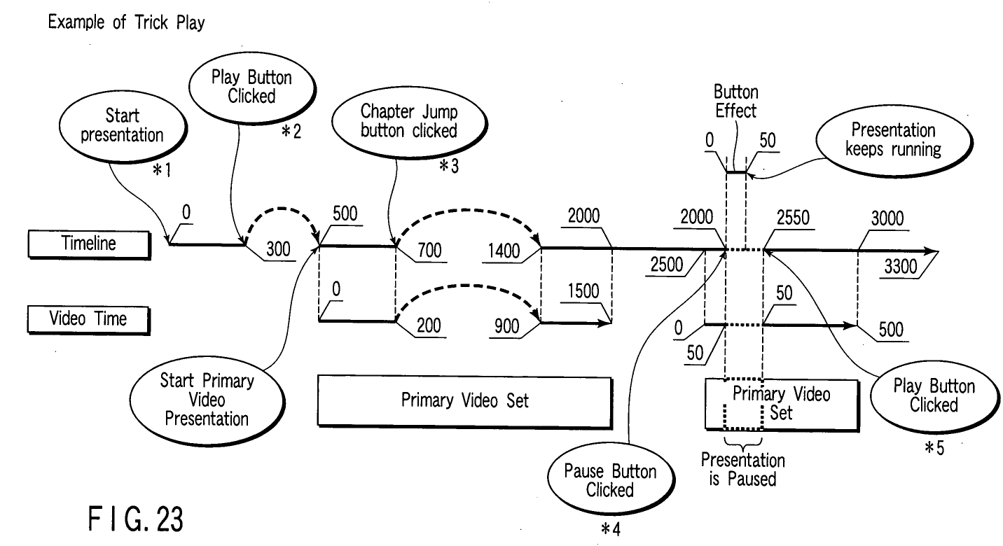

FIGS. 22 and 23 each give an explanation of Timeline used in a Playlist. FIG. 22 illustrates Allocation of Presentation Object on a Timeline. Here, a video frame unit, a unit of seconds (milliseconds), 90 kHz/27 MHz based clock unit, a unit specified by SMPTE and the like can be utilized for units of Timeline. In the example of FIG. 22, two Primary Video Sets respectively having time lengths of 1500 and 500 are prepared, and they are allocated to 500-1500 and 2500-3000 on Timeline that is one time axis. In this way, Objects having their respective time lengths are allocated onto Timeline that is one time axis, whereby their respective Objects can be reproduced without any discrepancy. Timeline can be configured to be zero reset for each Playlist to be used.

FIG. 23 is a diagram to help explain an example in which a trick play (such as chapter jump) of a Presentation Object is carried out on Timeline. FIG. 23 shows an example of advancement of time on Timeline when a playback operation is actually made. That is, when playback is started, a time on Timeline starts advancement *1. When a Play button is pressed at time 300 *2, the time on Timeline jumps 500, and playback of a Primary Video Set is started. Then, when a Chapter Jump button is pressed at time 700 *3, it jumps to a start position of the corresponding Chapter (to time 400 on Timeline in this case), playback is started therefrom. Then, a Pause button is clicked (by the player user) at time 2550 *4, a button effect occurs, and then, playback is Paused. When the Play button is clicked at time 2550 *5, playback is restarted.

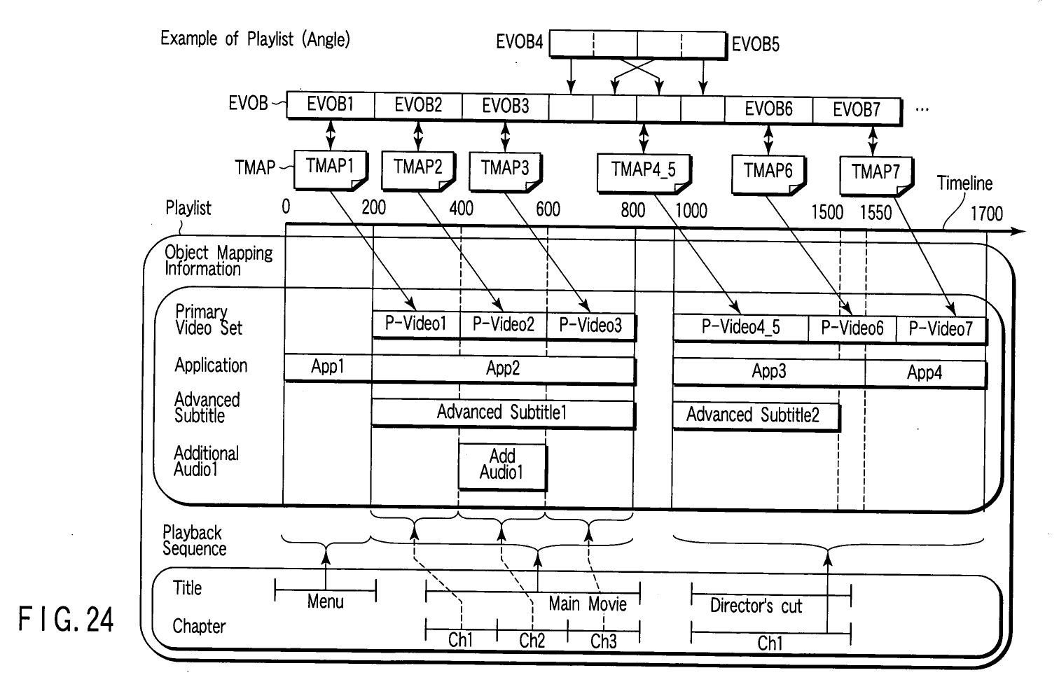

FIG. 24 shows an example of a Playlist in the case where EVOB has an interleaved angle. EVOB has a TMAP file corresponding thereto. On the other hand, with respect to EVOB4 and EVOB5 that are interleaved angle blocks, information is written in the same TMAP file. In addition, the respective TMAP files are specified in Object Mapping Information, thereby mapping the Primary Video Set on Timeline. In addition, Application, Advanced Subtitle, Additional Audio and the like are mapped on Timeline in accordance with description of the Object Mapping Information in the Playlist.

In the figure, as App1, Title that does not have Video or the like (such as Menu as its application) is defined between times 0 and 200 on Timeline. In addition, Application 2, Primary Videos 1-3, Advanced Subtitle 1, and Additional Audio 1 are set in a period of times 200 to 800. Primary Video 4_5 composed of EVOB4 and EVOB5 that configure an angle block, Primary Video 6, Primary Video 7, Applications 3 and 4, and Advanced Subtitle 2 are set in a period of times 1000 to 1700.

In addition, in a Playback sequence, it is defined that App1 configures Menu as one Title, App2 configures Main Movie, and App3 and App4 configure Director's cut. Further, Three Chapters and one Chapter are defined for Main Movie and Director's cut, respectively.

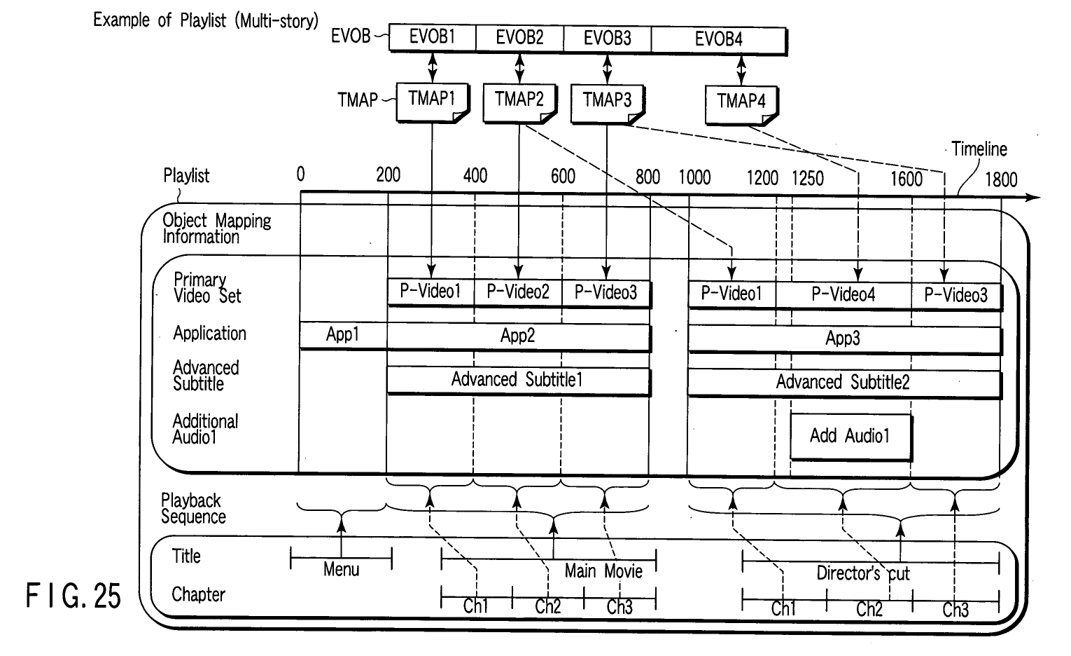

FIG. 25 is a diagram to help explain an exemplary configuration of a Playlist in the case where an Object includes Multi-Story. FIG. 25 is an imaginary view of a Playlist in the case of setting Multi-Story. TMAP is specified into the Object Mapping Information, whereby these two titles are mapped onto Timeline. In this example, EVOB1 and EVOB3 are used in both titles, and then, EVOB2 and EVOB4 are exchanged with each other, thereby enabling Multi-Story.

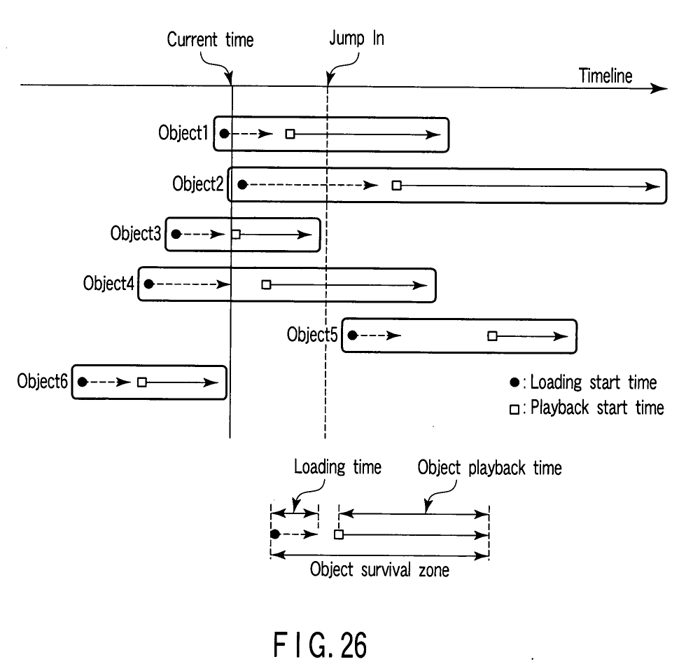

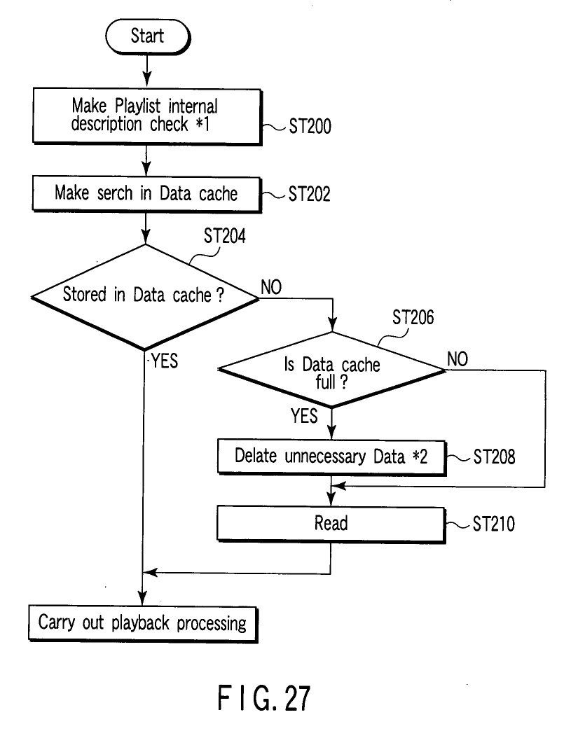

Further, a description will be given with respect to a Playlist. FIGS. 26 and 27 are diagrams to help explain a Playlist.

A playback time as well as a load time is described in the Playlist. A read time is described in information of the Playlist, thereby making it possible to measure (or detect) a use quantity of Data Cache. In this manner, the measurement (detection) result of the Data Cache use quantity is utilized, thereby enabling effective content production at the time of authoring. In addition, an Object that may not be erased is maintained in the Data Cache, thereby making it possible to improve the Player's performance. A further description will be given below.

FIG. 26 is a diagram exemplifying a playback time and a loading start time of each Object on Timeline. In the case where a current time expressed by the straight line in the figure jumps to a time expressed by the dotted line, Object 3 and Object 6 are at a time at which playback has already been terminated, and thus, there is no need for consideration thereof.

In addition, Object 5 does not arrive at a Loading start time yet, and thus, there is no need for consideration thereof. With respect to Object 1, although Loading has already started at a current time, it is not terminated. In addition, in a jump destination, this Object is in the middle of playback. Thus, contents similar to those of Object 1 owned by another file are loaded and played back. Object 2 has jumped to Loading in progress. Thus, with respect to this object as well, playback is started after Loading is completed by at least jump destination from the Loading start time.

Object 4 has jumped from a time at which Loading has been completed. Thus, the inside of Data cache is retrieved, and then, it is verified as to whether there exists is Object 4. If the existence is verified, playback is carried out. This can be accomplished by adding a Loadstart attribute to description of the Playlist.

FIG. 27 is a flowchart corresponding to the above processing. In the case where a jump operation has been made, description in a Playlist is checked (step ST200), and then, a search is made as to whether or not an Object is stored in a Data Cache (step ST202). In the case where the Object is stored in the Data Cache (Yes in step ST204), playback is carried out using it.

In the case where no Object is stored in the Data Cache (No in step ST204), it is checked whether or not there is any free space for storage in the Data Cache (step ST206). In the case where the Data Cache is full (Yes in step ST206), deletion of unnecessary objects is carried out (step ST208), required data is read from a file provided into the Data Cache (step St210), and then, playback is carried out.

In the case where there is a free space in the Data Cache (No in step ST206), Object deletion from the Data Cache is not carried out, reading of required data into the Data Cache is carried out (step ST210), and then, playback is carried out. In this manner, deletion of the stored contents is not carried out, thereby making it possible to retrieve and use the contents stored in the Data Cache in the case where the contents are required again by means of a jump operation or the like. Thus, the Player's capability can be improved by sufficiently providing the capacity of the Data Cache. In this manner, equipment differentiation can be promoted.

Further, the use quantity of the Data Cache by a predetermined times can be calculated (by adding the Loadstart attribute to the Playlist), thus making it possible to set a further Object in location that serves as a free space for storage in the capacity of the Data Cache at the time of production of contents, and then, enabling effective production of contents.

Management of the Playlist described above is carried out by means of a Playlist Manager in a Navigation Manager.

Here, a File System is prepared for a File Cache Manager. This File System manages a File or an Archived file or Archived Data stored in a File Cache. Namely, file write/readout of the File cache is controlled upon request from the Navigation Manager, a Presentation Engine, an Advanced Element Engine, and a Data Access Manager. The File Cache is part of a Data Cache, and is utilized as a location for temporarily storing a file.

First, the File Cache is defined so as to have a storage region of at least 64 MB (Megabytes). The minimum capacity of the File Cache is defined, thereby making it possible to design a capacity of contents and management information of a recording medium. In addition, the size of one memory block in the File Cache is set to 512 bytes. This block size is determined as a consumption unit. Even if a one-byte file is written, 512 bytes are allocated, and then, are consumed. An access in units of 512 bytes enables easy, high-speed access. In addition, address management is facilitated.

The File Cache can handle multiple-file archived data (Archived Data) and non-archived files. For the name of the Archived Data, its file name is expressed using eight characters; extension is expressed using three characters; and a unique file name is assigned in a disc. In addition, the name of a file in the Archived Data is expressed using 32 bytes (including extension). In addition, the maximum file size is 64 MB. Further, the maximum number of files is defined to be 2000 in a disc and 2000 in Archive.

Resources are managed based on the following information. That is, mapping information on a Title Timeline described in Resource Information managed by a Playlist Manager; and a File list and a Delete List described in a Resource Management Table managed by a File Cache Manager.

In an access from an Application Programming Interface (API), the data under the control of the Playlist Manager is for readout only. A file in a temporary directory (Temp directory) prepared as an API directory can be read and written.

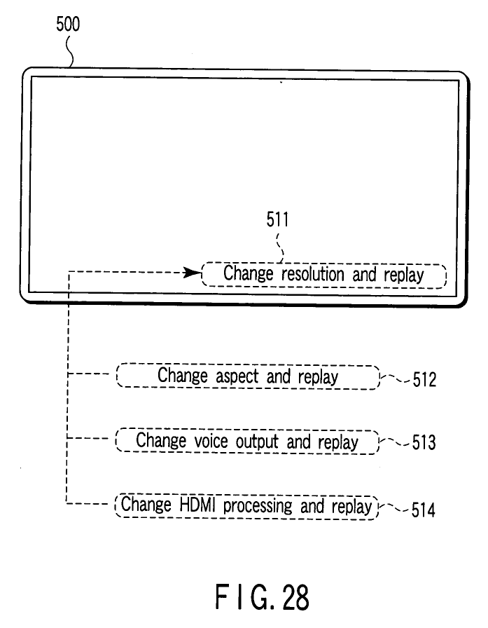

FIG. 28 shows an example in which a comment is displayed on a display device 500 connected to the apparatus when an aspect, resolution, a voice output, or an output mode has been changed in the apparatus described above. Outputs of these items of comment information are obtained by means of a Graphic Interface Controller (GUI Controller) 141 controlling a graphic decoder of a playback processing section.

For example, when a resolution change button is operated through a remote controller while playing back a disc in which advanced contents has been recorded, a comment 511 (for example, resolution change and replay) is displayed on a screen. In this manner, even if a user recognizes that resolution has been changed, and then, a player carries out replay from the start, no fault is mistakenly recognized. In addition, in the case where an aspect change button is operated, a comment 512 is displayed, and then, an operation for changing a voice output mode (such as the number of output channels or mixing mode) is made, a commend 513 is displayed. In addition, in the case where HDMI processing setting is changed, a comment 514 is displayed.

The setting change processing described above is executed by commanding change of system parameters of a memory 140. A variety of parameters described below, for example, are utilized as system parameters.

The parameters are classified in a variety of tables, for example. Player parameters are described in a table W1, and then, the described parameters are set in each player. Capability parameters are described in a table W2. These parameters show capability relevant to the player video, audio, and network. A table W3 contains presentation parameters, and these parameters set a playback state. A table W7 has system parameters. Some examples of tables are shown below. Such system parameters are selected, thereby making it possible to change and set a processing mode of a playback processing section.

```
  [W1]
  MajorVersion=00000001 (Major version
information is supported)
  MinorVersion=00000000 (Minor version
information is not supported)
  DisplayMode=00000003 (Display mode is
supported)
  SizeofDataCache=67108864 (Size value of data
cache)
  PerformanceeLevel=00000001 (Performance level
is set)
  ClosedCaption=00000001 (Closed caption is
supported)
  SimplifiedCaption=00000000 (Closed caption is
supported)
  LargeFont=00000000 (Large character size is
not supported)
  ContrastDisplay=00000000 (Contrast display is
not supported)
  DescriptiveAudio=00000000 (Audio description
is not supported)
  ExtendedInteractionTimes=00000000 (Extended
interaction times are not set)
  [W2]
  EnableHDMIOutput=00000000 (HDMI output is not
supported)
  LinearPCMSupportofMainAudio=00000002 (Main
audio supports linear PCM)
  DDPlusSupportofMainAudio=00000002 (Main audio
supports dolby digital plus)
  MPEG AudioSupportofMainAudio=00000001 (Main
audio supports MPEG audio)
  DTSHDSupportofMainAudio=00000002 (Main audio
supports DTS in HD)
  MLPSupportofMainAudio=00000001 (Main audio
supports MLP)
  DDPlusSupportofSubAudio=00000001 (Sub audio
supports dolby digital plus)
  DTSHDSupportofSubAudio=00000001 (Sub audio
supports DTS in HD)
  MPEG-4HEAACv2SupportofSubAudio=00000000
  mp3SupportofSubAudio=00000000
  WMAProSupportofSubAudio=00000000
  SupportofAnalogAudioOutput=00000002 (Analog
audio is supported)
  SupportofHDMI=00000002 (HDMI is supported)
  SupportofSPDIF=00000002 (S/PDIF is supported)
  EncodingSupportofSPDIF=00000001 (Encode
S/PDIF is supported)
  DirectOutputtoSPDIFofDolbyDigital=00000001
(Support for directly outputting digital dolby to
S/PDIF is available)
  DirectOutputtoSPDIFofDTS=00000001 (Support
for directly outputting DTS to S/PDIF is available)
  ResolutionofSubVideo=00000001 (Support for
setting resolution of sub video image is available)
  NetworkConnection=00000001 (Support relating
to network connection is available)
  NetworkThroughput=00000000
  SupportofOpenTypeFontTables=00000001 (Font
table of open type is supported)
  SupportofSlowForward=00000001 (Low speed
playback is supported)
  SupportofSlowReverse=00000000
  SupportofStepForward=00000001
  SupportofStepReverse=00000000
  [W3]
  SelectedAudioLanguageCode=“E” (English is
available as language code of selected Audio)
  SelectedAudioLanguagecode Extention=00000000
  SellectedSubtitleLangaugecode=“EN” (English
is available as language code of selected Subtitle)
  SelectedSubtitleLanguagecodeExtention=00000000
  [W7]
  MenuLanguage=“EN” (English is available as
menu language)
  CountryCode=“US” (Country code is the United
States)
  ParentalLevel=00000000
```

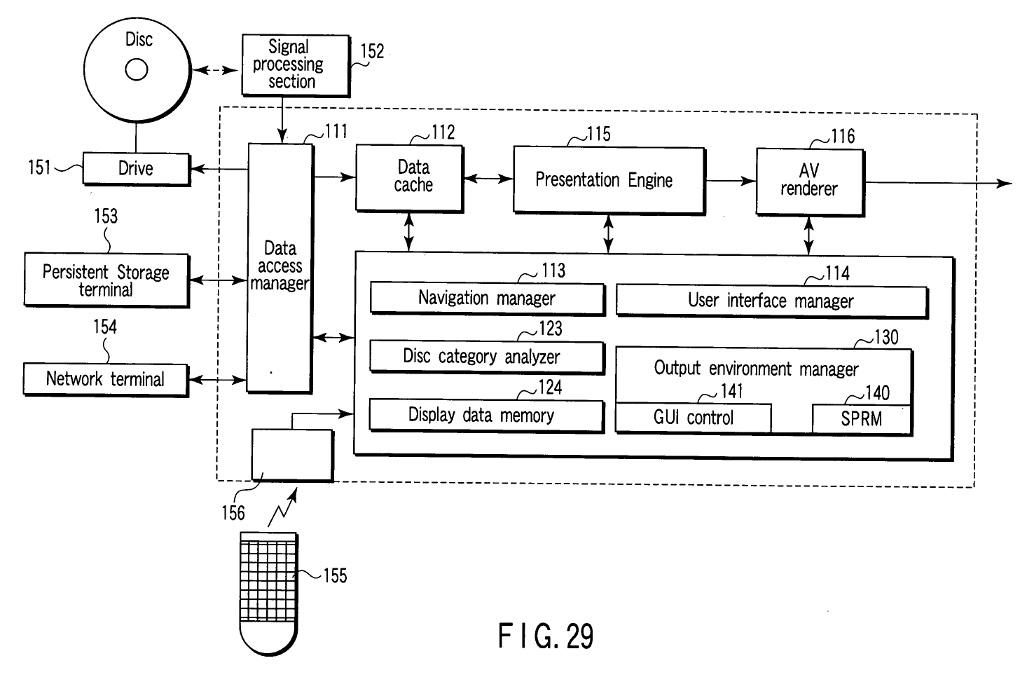

FIG. 29 shows a simplified whole block of a player. The data recorded in a disc can be acquired in a data access manager 111 via a signal processing section 152. A drive 151 carries out disc rotation, tracking, and focus control. In addition, persistent storage data can be acquired in the data access manager 111 via a persistent storage terminal 153. Further, network server data can be acquired in the data access manager 111 via a network terminal 154. In addition, an operating signal from a Remote Controller 155 is acquired in a user interface manager 114 via a control signal receiving section 156. Hereinafter, like constituent elements corresponding to those of FIG. 14 are designated by like reference numerals of FIG. 14. A duplicate description thereof is omitted here.

This invention is not limited to the embodiments described above, and can be carried out by modifying constituent elements without departing from the spirit of the invention at a stage of embodying the invention. In addition, a variety of inventions can be formed by using a proper combination of a plurality of constituent elements disclosed in the embodiments described above. For example, some constituent elements may be deleted from all the constituent elements disclosed in the embodiments. Further, constituent elements according to different embodiments may be properly combined with each other.

While certain embodiments of the inventions have been described, these embodiments have been presented by way of example only, and are not intended to limit the scope of the inventions. Indeed, the novel methods and systems described herein may be embodied in a variety of forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information reproducing apparatus, comprising:
a playback processing section which, in order to play back disc contents, plays back the contents based on playback management information;
a continuation control section which, in the case where output setting information of any of an aspect, resolution, and audio is changed in the middle of playback of first contents from the disc, changes setting of the playback processing section according to the output setting information, and then, continues playback; and
a replay control section which, in the case where output setting information of any of an aspect, resolution, and audio is changed in the middle of playback of second contents from the disc, establishes the playback processing section in a playback state from an object start position of an object of the disc.

2. The information reproducing apparatus according to claim 1, further comprising a disc type storage section having stored therein disc determination information for determining a first type and a second type other than the first type as a disc type at the time of starting playback,
wherein the continuation control section and the replay control section make operations according to contents of the type, referring to the disc determination information, respectively.

3. The information reproducing apparatus according to claim 1, wherein the replay control section starts operation from reading of a disc identification data file under a directory of the disc when setting a playback state from an object start position of an object of the disc.

4. The information reproducing apparatus according to claim 1, the replay control section reads a playlist showing procedures for playing back advanced contents relevant to the disc and sets a playback state when setting a playback state from an object start position of an object of the disc.

5. The information reproducing apparatus according to claim 1, wherein the playback processing section includes:
a user interface manager which accepts a user operation, and then, assigns an operating command to the continuation control section and the replay control section;
a data access manager which acquires data from a network server and a persistent storage in addition to the disc;
a data cache;
a presentation engine which decodes an output from the data cache; and
a navigation engine which controls the data cache and the presentation engine,
wherein the data access manager acquires contents from the network server and the persistent storage according to operating information inputted from the user interface; the navigation engine and the data cache expand the acquired contents; and the presentation engine obtains a playback output of an object included in contents.

6. The information reproducing apparatus according to claim 1, wherein the replay control section outputs a display comment to the effect that a replay is carried out via a graphic user interface control section when the replay is commanded to the playback processing section.

7. An information reproducing method having a playback processing section which, in order to play back disc contents, plays back the disc based on playback management information; and an output environment manager which sets a display mode of a video signal and an output mode of an audio signal outputted from the playback processing section, based on output setting information, the method comprising the steps of:
in the case where the output setting information of any of an aspect, resolution, and audio is changed in the middle of playback of first contents of a disc, changing setting of the playback processing section according to the output setting information, and then, continuing playback; and
in the case where the output setting information of any of an aspect, resolution, and audio is changed in the middle of playback of second contents of the disc, establishing the playback processing section in a playback state from an object start position of an object of the second contents.

8. The information reproducing method according to claim 7, further comprising the steps of:
storing disc determination information for determining a first type and a second type other than the first type as a disc type at the time of starting playback; and
carrying out determination of the first and second contents based on the disc determination information.

9. The information reproducing method according to claim 7, further comprising the step of, when setting a playback state from an object start position of an object of the second contents, starting from reading of a disc identification data file under a directory of the disc.

10. The information reproducing method according to claim 7, further comprising the step of, when setting a playback state from an object start position of an object of the second contents, reading a play list showing procedures for playing back advanced contents relevant to the disc, and then, setting a playback state.

11. The information reproducing method according to claim 7, wherein the playback processing section includes:
a user interface manager;
a data access manager;
a data cache;
a presentation engine; and
a navigation engine,
wherein the data access manager acquires contents from the network server and the persistent storage according to operating information inputted from the user interface; the navigation engine and the data cache expand the acquired contents; and the presentation engine obtains a playback output of an object included in contents.

12. The information reproducing method according to claim 7, comprising the step of, when the replay is started, outputting a display comment to the effect that a replay is carried out via a graphic user interface control section.
